(19) United States
(12) Patent Application Publication
(10) Pub. No.: US 2025/0214498 A1
(43) Pub. Date: Jul. 3, 2025

(54) VEHICLE SEAT SYSTEM

(71) Applicant: TS TECH CO., LTD., Asaka-shi, Saitama (JP)

(72) Inventors: Yuto AOKI, Shioya-gun, Tochigi (JP); Takuma KONNO, Shioya-gun, Tochigi (JP); Ryosuke KOJIMA, Shioya-gun, Tochigi (JP); Kensuke MIZOI, Shioya-gun, Tochigi (JP); Hiroshi TAKANOHASHI, Shioya-gun, Tochigi (JP); Kazuki KOBAYASHI, Shioya-gun, Tochigi (JP); Hajime YOSHIDA, Shioya-gun, Tochigi (JP)

(21) Appl. No.: 18/730,166

(22) PCT Filed: Dec. 26, 2022
(86) PCT No.: PCT/JP2022/047918

§ 371 Date: Mar. 12, 2025

Related U.S. Application Data
(60) Provisional application No. 63/301,175, filed on Jan. 20, 2022.

(30) Foreign Application Priority Data
Mar. 30, 2022 (JP) 2022-056457
Mar. 30, 2022 (JP) 2022-056462
Dec. 8, 2022 (JP) 2022-196218

(51) Int. Cl. B60N 2/90; B60N 2/00; B60N 2/64; B60N 2/68

(52) U.S. Cl. CPC B60N 2/90; B60N 2/0033; B60N 2/64; B60N 2/68; B60N 2002/981

(57) ABSTRACT

Provided is a vehicle seat system configured to efficiently notify an occupant of information external to a vehicle. The vehicle seat system includes a seat body mounted on a vehicle, the seat body having a seat cushion and a seatback, an external information acquisition device for acquiring external information, which is information external to the vehicle, one or more first vibration devices provided in the seat cushion, one or more second vibration devices provided in the seatback, and a control device configured to control the first and second vibration devices according to the external information, wherein the control device causes one of the first and second vibration devices to vibrate, followed by causing the other of the first and second vibration devices to vibrate.

### TECHNICAL FIELD

The present invention relates to a vehicle seat system.

### BACKGROUND ART

Known vehicle technologies include a vehicle travel direction teaching system for teaching an occupant within a vehicle the travel direction of an own vehicle (See Patent Document 1, for example). The system of Patent Document 1 is configured such that, when predicting a change in a travel direction of a vehicle, the system provides vibration by activating actuators installed in a vehicle seat one by one to thereby teach the travel direction to an occupant.

### PRIOR ART DOCUMENT(S)

### Patent Document(s)

Patent Document 1: JP2009-115553A

### SUMMARY OF THE INVENTION

### Means to Accomplish the Task

In order to solve the above problem of the prior art, an aspect of the present invention provides a vehicle seat system (1) comprising: a seat body (4) mounted on a vehicle (2), the seat body having a seat cushion (5) and a seatback (6); an external information acquisition device (63) for acquiring external information, which is information external to the vehicle; one or more first vibration devices (30) provided in the seat cushion; one or more second vibration devices (60) provided in the seatback; and a control device (35) configured to control the first and second vibration devices according to the external information, wherein the control device is configured to cause one of the first and second vibration devices to vibrate, followed by causing the other of the first and second vibration devices to vibrate.

According to this configuration, the first vibration devices provided in the seat cushion and the second vibration devices provided in the seatback vibrate in order. Since the first vibration devices and the second vibration devices, which are provided in two locations spaced apart from each other, vibrate in order, the system can effectively notify an occupant of external information i.e., information external to the vehicle.

The above vehicle seat system may be further configured such that the first vibration devices comprise one or more front first vibration devices located in a front part of the seat cushion and one or more rear first vibration devices located in a rear part of the seat cushion, and the second vibration devices comprise one or more upper second vibration devices located in an upper part of the seatback and one or more lower second vibration devices located in a lower part of the seatback, wherein the control device causes the first vibration devices and the second vibration devices to vibrate in a first vibration pattern or a second vibration pattern, wherein, in the first vibration pattern, the control device causes the first vibration devices to vibrate in order from the front first vibration devices to the rear first vibration devices, and then causes the second vibration devices to vibrate in order from the lower second vibration devices to the upper second vibration devices, whereas, in the second vibration pattern, the control device causes the second vibration devices to vibrate in order from the upper second vibration devices to the lower second vibration devices, and then causes the first vibration devices to vibrate in order from the rear first vibration devices to the front first vibration devices.

In this configuration, the system ensures that the system notifies an occupant of external information i.e., information external to the vehicle.

The above vehicle seat system may be further configured such that, when determining, based on the external information, that an object (75) is present frontward of the vehicle, the control device causes the first and second vibration devices to vibrate in the first vibration pattern, whereas, when determining that an object is present rearward of the vehicle, the control device causes the first and second vibration devices to vibrate in the second vibration pattern.

In this configuration, since the direction in which the object is present as seen from the vehicle is the same as the direction in which the vibration devices begin to vibrate in order, the system can intuitively notify an occupant of the presence of an object outside.

The above vehicle seat system may be further configured such that the control device causes the first and second vibration devices to vibrate in order, at predetermined intervals, and is configured to change the intervals based on the external information.

This configuration can clearly notify an occupant in the vehicle of external information by changing the vibration interval between the first vibration devices and the second vibration devices.

The above vehicle seat system may be further configured such that the control device changes the intervals based on the external information such that the closer the distance between the vehicle and the object is, the shorter the intervals.

In this configuration, the system can notify an occupant that the distance between the vehicle and the object is close.

The above vehicle seat system may be further configured such that the vehicle seat system further comprises an acceleration sensor (78) for detecting an acceleration of the vehicle, wherein the first vibration devices comprise a first set of vibration devices consisting of a plurality of front first vibration devices located in a front part of the seat cushion and a second set of vibration devices consisting of a plurality of rear first vibration devices located in a rear part of the seat cushion, and the second vibration devices comprise a third set of vibration devices consisting of a plurality of lower second vibration devices located in a lower part of the seatback and a fourth set of vibration devices consisting of a plurality of upper second vibration devices located in an upper part of the seatback, and wherein, when the acceleration of the vehicle is below a predetermined threshold value, the control device causes the first and second vibration devices to vibrate in order of the first, second, third, and fourth sets of vibration devices.

In this configuration, the system can notify an occupant that the acceleration is equal to or less than the predetermined threshold value.

The above vehicle seat system may be further configured such that the vehicle seat system further comprises an occupant detection device (61) for detecting that an occupant is seated in the seat body, wherein when determining, based on a signal from the occupant detection device, that an occupant is not seated in the seat body, the control device prohibits the first and second vibration devices from vibrating.

In this configuration, when an occupant is not seated in the seat body, the system can prevent unnecessary vibration of the first vibration devices and the second vibration devices.

The above vehicle seat system may be further configured such that the vehicle seat system further comprises a rotation angle sensor (62) for detecting a rotation angle of the seat body, wherein, when an object is present frontward of the vehicle and the rotation angle is less than a predetermined threshold value, the control device determines that the seat body is facing frontward and causes the first vibration devices to vibrate, followed by causing the second vibration devices to vibrate, whereas, when an object is present frontward of the vehicle and the rotation angle is equal to and greater than the predetermined threshold value, the control device determines that the seat body is facing rearward and causes the second vibration devices to vibrate, followed by causing the first vibration devices to vibrate.

In this configuration, even when the seat body is facing rearward, the system enables the direction in which the object is present as seen from the vehicle to be the same as the direction in which the vibration devices begin to vibrate in order in the seat body. Thus, the system can intuitively inform an occupant in the vehicle of the external information.

The above vehicle seat system may be further configured such that, when the object is present frontward to a first side of the vehicle, the first side being one of the left and right side and a second side being the other, and the rotation angle is less than the predetermined threshold value, the control device determines that the seat body is facing frontward and causes the first and second vibration devices provided on the first side of the seat body to vibrate, followed by causing the first and second vibration devices provided on the second side of the seat body to vibrate, whereas, when the object is present frontward to the first side of the vehicle and the rotation angle is equal to or greater than the predetermined threshold value, the control device determines that the seat body is facing rearward and causes the first and second vibration devices provided on the second side of the seat body to vibrate, followed by causing the first and second vibration devices on the first side of the seat body to vibrate.

In this configuration, even when the seat body is facing rearward, the system enables the lateral direction in which the object is present as seen from the vehicle to be the same as the direction in which the vibration devices begin to vibrate in order in the seat body. Thus, the system can intuitively inform an occupant in the vehicle of the external information.

The above vehicle seat system may be further configured such that the seatback includes a pressure receiving member (45) with main surfaces facing frontward and rearward of the seat body, the pressure receiving member being configured to receive a pressure applied from a body of an occupant seated in the seat body, and wherein the second vibration devices are provided frontward of, and not overlapping with the pressure receiving member in a front-rear direction.

In this configuration, when the vehicle is hit from behind, the second vibration devices are prevented from interfering with on the occupant.

Known vehicle seats include a vehicle seat configured to blow temperature-controlled air around the body of a seated person. For example. Patent Document. JP2021-061875A discloses a vehicle seat configured to blow air toward a seated person from a pair of air outlets provided at lower left- and right-side parts of the seatback. In this configuration, ducts having air outlets extend along and behind the left and right side banks of a pad of a seatback, and are connected to an air supply unit for supplying air.

In the above-described prior art, as the ducts extend along and behind the left and right banks of the pad of the seatback, air passages cannot be made compact.

The present invention has been made in view of such a problem of the prior art, and a primary object of the present invention is to provide a vehicle seat that enables air passages within the seat to be compactly arranged.

In order to solve the above problem of the prior art, provided is a vehicle seat comprising: a seat body in which a person can be seated; and a temperature control device configured to enable temperature-controlled air to be blown from a seated person's side of the seat body, wherein the seat body comprises: a seat frame including left and right side frames which are spaced apart from each other, and a connecting frame configured to connect the left and right side frames at their respective longitudinal ends, which are ends in a longitudinal direction; a pressure receiving member that is plate-shaped and configured to support a seated person between the right and left side frames; a seat pad configured to cover the seat frame and the pressure receiving member, wherein the temperature control device comprises: a first air blowing unit capable of blowing temperature-controlled air; and an air passage forming member configured to direct air from the first air blowing unit to a surface on the seated person's side of the seat body, the air passage forming member having a blowout port for blowing air from the first air blowing unit, and wherein the air passage forming member extends from the seated person's side to an opposite side to the seated person's side through a placement space, which is a space surrounded by one of the left and right side frames, the connecting frame, and the pressure receiving member.

This configuration allows the air passage forming member, which is an air passageway, to be compactly arranged. This configuration further allows the side frame, the connecting frame, and the pressure receiving member to prevent the air passage forming member from moving and also protect the air passage forming member.

The above vehicle seat may be further configured such that the vehicle seat further comprises an air conditioning device capable of blowing air to and/or drawing air from the surface on the seated person's side of the seat body, wherein the air conditioning device comprises: a second air blowing unit forming an air flow; and a duct which allows the second air blowing unit to connect to and communicate with a seat air passage formed in the seat pad, wherein the duct is connected to and in communication with the seat air passage through a through-hole formed in the pressure receiving member, and wherein a space portion of the air passage forming member which passes through the placement space is located within an overlap in the longitudinal direction with a portion of the duct where the duct is connected to the seat air passage.

This configuration allows the air passage forming member and the duct to be compactly arranged. In addition, since a portion of the pressure receiving member is placed between the air passage forming member and the duct, the pressure receiving member prevents the air passage forming member from interfering with the duct.

The above vehicle seat may be further configured such that the seat body comprises an inner cover for covering an inner side of the one of the left and right side frames, wherein the air passage forming member extends between the connecting frame and the inner cover.

In this configuration, the air passage forming member and the inner cover can be arranged side by side in the front-rear direction, which allows the air passage forming member and the inner cover to be compactly arranged in the left-right direction, and further allows the inner cover to prevent the air passage forming member from moving and also protect the air passage forming member.

The above vehicle seat may be further configured such that the pressure receiving member comprises a metal wire member, and a coating member made of a non-metal and configured to cover the metal wire member, and wherein the metal wire member comprises a first extension portion extending through an edge of the pressure receiving member, the placement space being formed by the edge of the pressure receiving member, the pressure receiving member, and the one of the left and right side frames.

In this configuration, the edge of the pressure receiving member is stiffened by the first extension portion of the metal wire member extending therethrough, enabling the formation of a placement space SP, through which the air passage forming member passes.

The above vehicle seat may be further configured such that the first extension portion extends in the longitudinal direction, and wherein the metal wire member comprises: a second extension portion extending from a longitudinal end of the first extension portion toward one of the left and right; and a bend formed between the first extension portion and the second extension portion.

In this configuration, the bend further stiffens a region near the first extension portion of the metal wire member, thereby further increasing the stiffness of the edge of the pressure receiving member, which forms the placement space through which the air passage forming member passes.

The above vehicle seat may be further configured such that the vehicle seat further comprises a vibration generating device for generating vibration, wherein the vibration generating device is provided inside a contour of the pressure receiving member as viewed from the seating person's side, and wherein a space portion of the air passage forming member which passes through the placement space is located at a longitudinal range which overlaps with a longitudinal position of the vibration generating device.

This configuration allows the air passage forming member and the vibration generating device to be compactly arranged in the longitudinal direction. Since a part of the pressure receiving member is positioned between the air passage forming member and the vibration generating device, the air passage forming member is prevented from interfering with and the vibration generating device.

The above vehicle seat may be further configured such that a space portion of the air passage forming member which passes through the placement space is located within a location between one longitudinal end and the other longitudinal end of the pressure receiving member.

This configuration allows the air passage forming member and the pressure receiving member to be compactly arranged in the longitudinal direction.

The above vehicle seat may be further configured such that the pressure receiving member comprises: a first hook portion formed at one longitudinal end and configured to be hooked onto the seat frame; and a second hook portion formed at the other longitudinal end and configured to be hooked onto the seat frame; wherein the space portion of the air passage forming member which passes through the placement space is positioned between the first and second hook portions in the longitudinal direction.

This configuration prevents the air passage forming member from interfering with a member(s), onto which the pressure receiving member of the seat frame is hooked.

The above vehicle seat may be further configured such that the connecting frame is a pan frame made of seat metal.

The above vehicle seat may be further configured such that the air passage forming member comprises: a filler having breathability; and a bag for covering the filler having one end which is connected to the first air blowing unit, and the other end in which the blowout port is formed.

The above vehicle seat may be further configured such that the seat body comprises: a seat cushion including therein the left and right side frames, the connecting frame, and the pressure receiving members; a seatback; and a headrest, and wherein the vehicle seat further comprises: a reclining mechanism configured to connect the seatback to the seat cushion in a rotatable manner; and a moving mechanism configured to enable the seat cushion to move with respect to a vehicle floor.

In another aspect of the present invention, provided is a vehicle seat comprising: a seat body in which a person can be seated; and a temperature control device configured to enable temperature-controlled air to be blown from a seated person's side of the seat body, wherein the seat body comprises: a seat frame; a seat pad configured to cover the seat frame; and a skin cover configured to cover the seat frame and the seat pad, wherein the temperature control device comprises: a first air blowing unit capable of blowing temperature-controlled air; and an air passage forming member configured to direct air from the first air blowing unit to a surface on the seated person's side of the seat body, the air passage forming member having a blowout port for blowing air from the first air blowing unit, and wherein the seat pad has a draw-in groove for drawing the skin cover therein and a first pad hole extending through the seat pad from the seated person's side to an opposite side, wherein the draw-in groove includes a first groove extending in a predetermined direction, wherein the first pad hole is formed on a same side as the side on which the blowout port is located with regard to the first groove, and wherein the air passage forming member extends from the seated person's side to a opposite side through the first pad hole.

This configuration allows the air passage forming members, which are air passages, to be compactly arranged. The first pad hole is positioned on the same side as the blowout ports of the air passage forming member with respect to the first groove of the draw-in groove, and thus, the first groove does not cross a portion of the air passage forming member which exits to the seated person's side, which prevents the air passage forming member from becoming an obstacle when the skin cover is drawn in the first draw-in groove.

The above vehicle seat may be further configured such that the air passage forming member forms part of an inner surface of the first groove.

This configuration allows the air passage forming member to be arranged so as to be in contact with the first draw-in groove, enabling the air passage forming member to be compactly arranged.

The above vehicle seat may be further configured such that the seat frame includes a seat cushion frame forming a frame of a seat cushion, wherein the pad includes a seat cushion pad configured to cover the seat cushion frame, wherein the skin cover includes a seat cushion skin cover configured to cover the seat cushion frame and the seat cushion pad, wherein the seat cushion pad has a first central portion, and left and right first side portions provided on the respective sides of the first central portion and protruding above the first central portion, wherein the first groove comprises left and right first groove parts extending between the first central portion and the left and right first side portions, respectively, wherein the left and right first side portions have respective first recesses, and wherein the air passage forming member comprises left and right first air passage forming members, which are placed in the corresponding first recesses, respectively.

In this configuration, the first recess is formed in the first side portion of the seat cushion pad where a pressure is hardly applied from the seated person, thereby allowing the seat cushion pad to be made thinner at a position which is less likely to affect the comfort of seating.

The above vehicle seat may be further configured such that a seated person's side faces of each of the left and right air passage forming members placed in the corresponding first recess is flush with a seated person's side face of a corresponding one of the left and right first side portions around the first recess, in which the air passage forming member is placed.

In this configuration, the shape of the air passage forming member is less likely to appear on the surface of the seat cushion, allowing the air passage forming member to be arranged without negatively affecting the design of the vehicle seat.

The above vehicle seat may be further configured such that the vehicle seat comprises a vibration generating device configured to generate vibration, wherein the first pad hole is located within a range along a predetermined direction which overlaps with a position of the vibration generating device along the predetermined direction.

This configuration allows a part of the air passage forming member passing through the first pad hole and the first vibration generating device to be compactly arranged in the predetermined direction, in which the first groove extends.

The above vehicle seat may be further configured such that the seat frame includes a seatback frame forming a frame of a seatback frame, wherein the seat pad includes a seatback pad configured to cover the seatback frame; and wherein the skin cover includes a seatback skin cover configured to cover the seatback frame and the seatback pad, wherein the seatback pad has a second central portion, and left and right second side portions provided on the respective sides of the second central portion and protruding frontward of the second central portion, wherein the first groove comprises left and right second groove parts extending on the left and right sides of the second central portion, wherein the second central portion has a second recess, and wherein the air passage forming member comprises second air passage forming member, which is placed in the second recess.

This configuration allows temperature-controlled air to be blown from the laterally center part of the seatback.

The above vehicle seat may be further configured such that the vehicle seat further comprises a support member provided on the opposite side to a seated person's side of the seat pad and configured to support the seated person, and wherein the first air blowing unit is secured to the support member on an opposite side to the seated person's side of the support member.

This configuration prevents a seated person from having a foreign body sensation due to the placed seat cushion air blowing units.

The above vehicle seat may be further configured such that the vehicle seat further comprises a plate-like pressure receiving member provided on the opposite side to a seated person's side of the seat pad and configured to support the seated person, wherein the seat frame has left and right side frames which are spaced apart from each other, wherein the pressure receiving member comprises a body portion positioned between the left and right side frames in a left-right direction, and extensions extending from the left and right ends of the body portion to parts overlapping the side frames as viewed from a seated person's side, wherein the pressure receiving member has a through hole extending through the pressure receiving member from the seated person's side to an opposite side and formed to overlap the first pad hole as viewed from the seated person's side, and wherein the air passage forming member extends through the first pad hole and the through hole from the seated person's side to the opposite side.

This configuration allows the pressure receiving members to be arranged in the vehicle seat, even when the plate-shaped pressure receiving member for supporting a seated person has the extension portions.

The above vehicle seat may be further configured such that the vehicle seat further comprises an elastic member; and a plate configured to elastically support the pressure receiving member via the elastic member, wherein the plate is provided on the opposite side of the pressure receiving member from the seated person's side and extends across the left and right frames, wherein the first pad hole and the through hole are located at different positions from the plate as viewed from the seated person's side.

In this configuration, the air passage forming members are enabled to be provided, with the pressure receiving member being elastically supported.

The above vehicle seat may be further configured such that the vehicle seat further comprises a bag member having a bag-shaped portion which can expand and contract, and which is provided between the seat pad and the skin cover; and a hose connected to the bag member and allowing fluid to flow into and be discharged from the bag member, wherein the seat pad has a second pad hole extending through the seat pad from the seated person's side to the opposite side, wherein the second pad hole is formed on the opposite side of the first groove from the side on which the first pad hole is located, and wherein the hose extends through the second pad hole from the seated person's side to the opposite side of the seat pad.

In this configuration, the air passage forming member and the hose pass through the seat pad, with the first groove therebetween, which prevents the air passage forming member from interfering with the hose.

The above vehicle seat may be further configured such that the bag-shaped portion is positioned further away from the first groove than the second pad hole.

This configuration prevents the air passage forming member from interfering with the bag-shaped portion, which is capable of inflating and deflating.

The above vehicle seat may be further configured such that the vehicle seat further comprises an air conditioning device capable of blowing air to and/or drawing air from the surface on the seated person's side of the seat body; and a control unit capable of controlling the air conditioning device, wherein the control unit is arranged in alignment with a part of the air conditioning device and the first air blowing unit in an orthogonal direction that is orthogonal to the left-right direction, as viewed from the opposite side of the seated person side.

This configuration allows the control unit the air conditioning device, and the seat cushion air blowing unit to be compactly arranged in the left-right direction.

The above vehicle seat may be further configured such that the air conditioning device comprises: a second air blowing unit forming an air flow; and a duct which allows the second air blowing unit to connect to and communicate with a seat air passage formed in the seat pad, wherein the control unit is provided between the first and second air blowing units and in alignment with the first air blowing unit and the second blowing unit in the orthogonal direction, and in alignment with the duct in the left-right direction, as viewed from the opposite side of the seated person side.

This configuration allows the control unit, the first air blowing unit, and the second air blowing unit to be compactly arranged in the left-right direction, and also allows for efficient use of the space surrounded by the first air blowing unit, the second air blowing unit, and the duct.

The above vehicle seat may be further configured such that the seat body comprises a seat cushion, a seatback, and a headrest, and wherein the vehicle seat further comprises: a reclining mechanism configured to connect the seatback to the seat cushion in a rotatable manner; and a moving mechanism configured to enable the seat cushion to move with respect to a vehicle floor.

### Effect of the Invention

In order to achieve the above object, an aspect of the present invention provides a vehicle seat system (1) comprising: a seat body (4) mounted on a vehicle (2), the seat body having a seat cushion (5) and a seatback (6); an external information acquisition device (63) for acquiring external information, which is information external to the vehicle; one or more first vibration devices (30) provided in the seat cushion; one or more second vibration devices (60) provided in the seatback; and a control device (35) configured to control the first and second vibration devices according to the external information, wherein the control device is configured to cause one of the first and second vibration devices to vibrate, followed by causing the other of the first and second vibration devices to vibrate.

According to this configuration, the first vibration devices provided in the seat cushion and the second vibrations device provided in the seatback vibrate in order. Since the first vibration devices and the second vibration devices, which are provided in two locations spaced apart from each other, vibrate in order, the system can effectively notify an occupant of external information i.e., information external to the vehicle.

The above vehicle seat system may be further configured such that the first vibration devices comprise one or more front first vibration devices located in a front part of the seat cushion and one or more rear first vibration devices located in a rear part of the seat cushion, and the second vibration devices comprise one or more upper second vibration devices located in an upper part of the seatback and one or more lower second vibration devices located in a lower part of the seatback, wherein the control device causes the first vibration devices and the second vibration devices to vibrate in a first vibration pattern or a second vibration pattern, wherein, in the first vibration pattern, the control device causes the first vibration devices to vibrate in order from the front first vibration devices to the rear first vibration devices, and then causes the second vibration devices to vibrate in order from the lower second vibration devices to the upper second vibration devices, whereas, in the second vibration pattern, the control device causes the second vibration devices to vibrate in order from the upper second vibration devices to the lower second vibration devices, and then causes the first vibration devices to vibrate in order from the rear first vibration devices to the front first vibration devices.

In this configuration, the system ensures that the system notifies an occupant of external information i.e., information external to the vehicle.

The above vehicle seat system may be further configured such that, when determining, based on the external information, that an object (75) is present frontward of the vehicle, the control device causes the first and second vibration devices to vibrate in the first vibration pattern, whereas, when determining that an object is present rearward of the vehicle, the control device causes the first and second vibration devices to vibrate in the second vibration pattern.

In this configuration, since the direction in which the object is present as seen from the vehicle is the same as the direction in which the vibration devices begin to vibrate in order, the system can intuitively notify an occupant of the presence of an object outside.

The above vehicle seat system may be further configured such that the control device causes the first and second vibration devices to vibrate in order, at predetermined intervals, and is configured to change the intervals based on the external information.

This configuration can clearly notify an occupant in the vehicle of external information by changing the vibration interval between the first vibration devices and the second vibration devices.

The above vehicle seat system may be further configured such that the control device changes the intervals based on the external information such that the closer the distance between the vehicle and the object is, the shorter the intervals.

In this configuration, the system can notify an occupant that the distance between the vehicle and the object is close.

The above vehicle seat system may be further configured such that the vehicle seat system further comprises an acceleration sensor (78) for detecting an acceleration of the vehicle, wherein the first vibration devices comprise a first set of vibration devices consisting of a plurality of front first vibration devices located in a front part of the seat cushion and a second set of vibration devices consisting of a plurality of rear first vibration devices located in a rear part of the seat cushion, and the second vibration devices comprise a third set of vibration devices consisting of a plurality of lower second vibration devices located in a lower part of the seatback and a fourth set of vibration devices consisting of a plurality of upper second vibration devices located in an upper part of the seatback, and wherein, when the acceleration of the vehicle is below a predetermined threshold value, the control device causes the first and second vibration devices to vibrate in order of the first, second, third, and fourth sets of vibration devices.

In this configuration, the system can notify an occupant that the acceleration is equal to or less than the predetermined threshold value.

The above vehicle seat system may be further configured such that the vehicle seat system further comprises an occupant detection device (61) for detecting that an occupant is seated in the seat body, wherein when determining, based on a signal from the occupant detection device, that an occupant is not seated in the seat body, the control device prohibits the first and second vibration devices from vibrating.

In this configuration, when an occupant is not seated in the seat body, the system can prevent unnecessary vibration of the first vibration devices and the second vibration devices.

The above vehicle seat system may be further configured such that the vehicle seat system further comprises a rotation angle sensor (62) for detecting a rotation angle of the seat body, wherein, when an object is present frontward of the vehicle and the rotation angle is less than a predetermined threshold value, the control device determines that the seat body is facing frontward and causes the first vibration devices to vibrate, followed by causing the second vibration devices to vibrate, whereas, when an object is present frontward of the vehicle and the rotation angle is equal to and greater than the predetermined threshold value, the control device determines that the seat body is facing rearward and causes the second vibration devices to vibrate, followed by causing the first vibration devices to vibrate.

In this configuration, even when the seat body is facing rearward, the system enables the direction in which the object is present as seen from the vehicle to be the same as the direction in which the vibration devices begin to vibrate in order in the seat body. Thus, the system can intuitively inform an occupant in the vehicle of the external information.

The above vehicle seat system may be further configured such that, when the object is present frontward to a first side of the vehicle, the first side being one of the left and right side and a second side being the other, and the rotation angle is less than the predetermined threshold value, the control device determines that the seat body is facing frontward and causes the first and second vibration devices provided on the first side of the seat body to vibrate, followed by causing the first and second vibration devices provided on the second side of the seat body to vibrate, whereas, when the object is present frontward to the first side of the vehicle and the rotation angle is equal to or greater than the predetermined threshold value, the control device determines that the seat body is facing rearward and causes the first and second vibration devices provided on the second side of the seat body to vibrate, followed by causing the first and second vibration devices on the first side of the seat body to vibrate.

In this configuration, even when the seat body is facing rearward, the system enables the lateral direction in which the object is present as seen from the vehicle to be the same as the direction in which the vibration devices begin to vibrate in order in the seat body. Thus, the system can intuitively inform an occupant in the vehicle of the external information.

The above vehicle seat system may be further configured such that the seatback includes a pressure receiving member (45) with main surfaces facing frontward and rearward of the seat body, the pressure receiving member being configured to receive a pressure applied from a body of an occupant seated in the seat body, and wherein the second vibration devices are provided frontward of, and not overlapping with the pressure receiving member in a front-rear direction.

In this configuration, when the vehicle is hit from behind, the second vibration devices are prevented from interfering with on the occupant.

The above-described vehicle seat allows the air passage forming member, which is an air passageway, to be compactly arranged. This configuration prevents the air passage forming member from moving and also protects the air passage forming member.

In some cases, the duct is connected to and in communication with the seat air passage through a through-hole, and a space portion of the air passage forming member which passes through the placement space is located within a longitudinal range which overlaps with a longitudinal location where the duct is connected to the seat air passage. This configuration allows the air passage forming member and the duct to be compactly provided. Also, this configuration prevents the air passage forming member from interfering with the duct.

In some cases, the air passage forming member extends between the connecting frame and the inner cover, which allows the air passage forming member and the inner cover to be compactly arranged in the left-right direction, and prevents the air passage forming member from moving and also protects the air passage forming member.

In some cases, the metal wire member comprises a first extension portion extending through an edge of the pressure receiving member. In this configuration, the edge of the pressure receiving member is stiffened by the first extension portion of the metal wire member extending therethrough, enabling the formation of a placement space SP, through which the air passage forming member passes.

In some cases, the metal wire member comprises a second extension portion and a bend, which further increases the stiffness of the edge of the pressure receiving member, which forms the placement space through which the air passage forming member passes.

In some cases, the vibration generating device is provided inside a contour of the pressure receiving member as viewed from the seating person's side, and wherein a space portion of the air passage forming member which passes through the placement space is located within a longitudinal range which overlaps with the longitudinal position of the vibration generating device. This configuration allows the air passage forming member and the vibration generating device to be compactly arranged in the longitudinal direction, and prevents the air passage forming member from interfering with and the vibration generating device.

In some cases, a space portion of the air passage forming member which passes through the placement space is located within a location between one longitudinal end and the other longitudinal end of the pressure receiving member. This configuration allows the air passage forming member and the pressure receiving member to be compactly arranged in the longitudinal direction.

In some cases, the space portion of the air passage forming member which passes through the placement space is positioned between the first and second hook portions in the longitudinal direction, which prevents the air passage forming member from interfering with a member(s), onto which the pressure receiving member of the seat frame is hooked.

In the above vehicle seat, the air passage forming member is allowed to be compactly arranged. In addition, the air passage forming member is prevented from becoming an obstacle when the skin cover is drawn in the first draw-in groove.

In some cases, the above vehicle seat may be further configured such that the air passage forming member forms part of an inner surface of the first groove, enabling the air passage forming member to be compactly arranged.

In some cases, the first side portions have respective first recesses, which allows the seat cushion pad to be made thinner at a position which is less likely to affect the comfort of seating.

In some cases, a seated person's side faces of each of the t air passage forming members placed in the corresponding first recess is flush with a seated person's side face of a corresponding one of the first side portions, which allows the air passage forming member to be arranged without negatively affecting the design of the vehicle seat.

In some cases, the first pad hole is located within a range along a predetermined direction that overlaps with a position along the predetermined direction of the vibration generating device, which allows a part of the air passage forming member passing through the first pad hole and the first vibration generating device to be compactly arranged in the predetermined direction, in which the first groove extends.

In some cases, the second central portion has a second recess, which allows temperature-controlled air to be blown from the laterally center part of the seatback.

In some cases, the first air blowing unit is secured to the support member on an opposite side to the seated person's side of the support member, which prevents a seated person from having a foreign body sensation due to the placed seat cushion air blowing units.

In some cases, the air passage forming member extends through the first pad hole and the through hole from the seated person's side to the opposite side, which allows the pressure receiving members to be arranged in the vehicle seat, even when the plate-shaped pressure receiving member for supporting a seated person has the extension portions.

In some cases, the vehicle seat further comprises an elastic member; and a plate, and the first pad hole and the through hole are located at different positions from the plate as viewed from the seated person's side. In this configuration, the air passage forming members are enabled to be provided, with the pressure receiving member being elastically supported.

In some cases, the second pad hole of the seat pad is formed on the opposite side of the first groove from the side on which the first pad hole is located, and wherein the hose extends through the second pad hole. This configuration prevents the air passage forming member from interfering with the hose.

In some cases, the bag-shaped portion of the bag member is positioned further away from the first groove than the second pad hole. This configuration prevents the air passage forming member from interfering with the bag-shaped portion, which is capable of inflating and deflating.

In some cases, the control unit is arranged in alignment with a part of the air conditioning device and the first air blowing unit in an orthogonal direction that is orthogonal to the left-right direction, as viewed from the opposite side of the seated person side. This configuration allows the control unit the air conditioning device, and the seat cushion air blowing unit to be compactly arranged in the left-right direction.

In some cases, the control unit is provided between the first and second air blowing units and in alignment with the first air blowing unit and the second blowing unit in the orthogonal direction, and in alignment with the duct in the left-right direction. This configuration allows the control unit, the first air blowing unit, and the second air blowing unit to be compactly arranged in the left-right direction, and also allows for efficient use of the space surrounded by the first air blowing unit, the second air blowing unit, and the duct.

### BRIEF DESCRIPTION OF THE DRAWINGS

FIG. 1 is a perspective view of a seat body according to an embodiment of the present invention;

FIG. 2 is a plan view of a seat cushion pad:

FIG. 3 is a front view of the seat cushion pad;

FIG. 4 is cross-sectional view taken along line IV-IV in FIG. 3;

FIG. 5 is a perspective view of the seat body;

FIG. 6 is a block diagram of a vehicle seat system;

FIG. 7 is a diagram showing a positional relationship between a vehicle and the object;

FIG. 8 is a flowchart of a vibration operation of a first embodiment;

FIG. 9 is a flowchart of a vibration operation of a second embodiment;

FIG. 10 is a perspective view of a seat body according to another embodiment of the present invention;

FIG. 11 is a perspective view of a seat frame;

FIG. 12 is a diagram showing a seat cushion frame and a seat cushion pressure receiving member, and an inner cover, as viewed from the above;

FIG. 13 is a diagram showing the seat cushion pressure receiving member, as viewed from the above;

FIG. 14 is a diagram showing the seat cushion pad and a seat cushion air passage bag, as viewed from the above;

FIG. 15 is a diagram showing a seatback pad and a seatback air passage bag, as viewed from the front;

FIG. 16 is a perspective view of the seat cushion pad and an air conditioning device;

FIG. 17 is a perspective view of the seatback pad and a duct;

FIG. 18 is a diagram showing the vehicle seat, as viewed from the below;

FIG. 19 is a perspective view of the air conditioning device;

FIG. 20 is a cross-sectional view of around a first pad hole of the seat cushion;

FIG. 21 is a cross-sectional view of around a first pad hole of the seatback;

FIG. 22 is a perspective view of a vehicle seat of a first modified embodiment, showing a seat cushion frame, a seat cushion pad, a seat cushion pressure receiving member, a compression coil spring, a plate, and a temperature control device of a vehicle seat:

FIG. 23 is a diagram showing the seat cushion frame and a seat cushion pressure receiving member, as viewed from the above:

FIG. 24 is a perspective view of a vehicle seat of a second modified embodiment, showing a seat cushion pad, a seat cushion skin cover, bag members, and hoses;

FIG. 25 is a cross-sectional view of around a first pad hole of the seat cushion; and

FIG. 26 is a diagram showing a vehicle seat of a third modified embodiment, as viewed from the below.

### DESCRIPTION OF THE PREFERRED EMBODIMENT(S)

### First Embodiment

Embodiments of a vehicle seat system according to the present invention, in which the vehicle seat system is used in a motor vehicle as a vehicle, will be described with reference to the appended drawings.

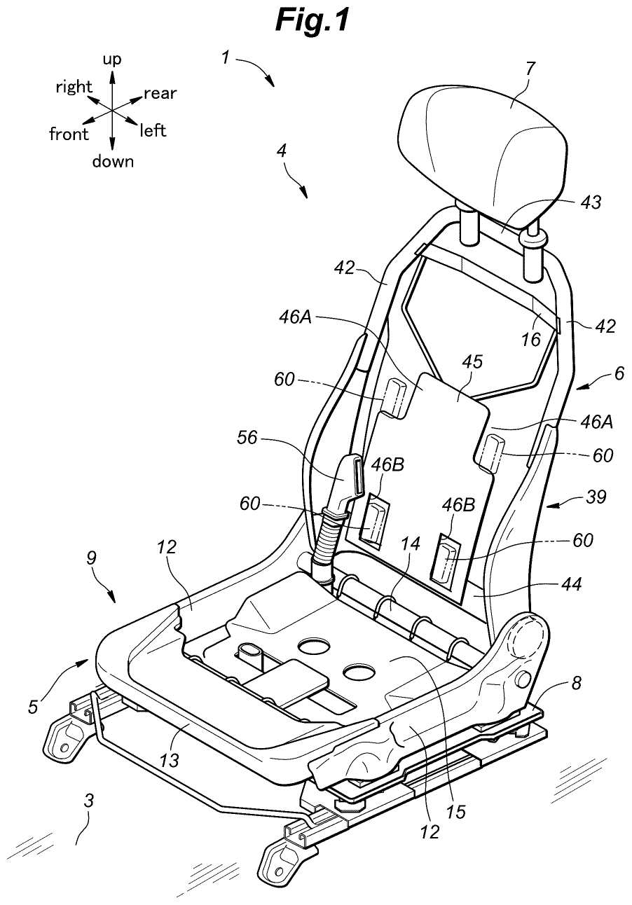

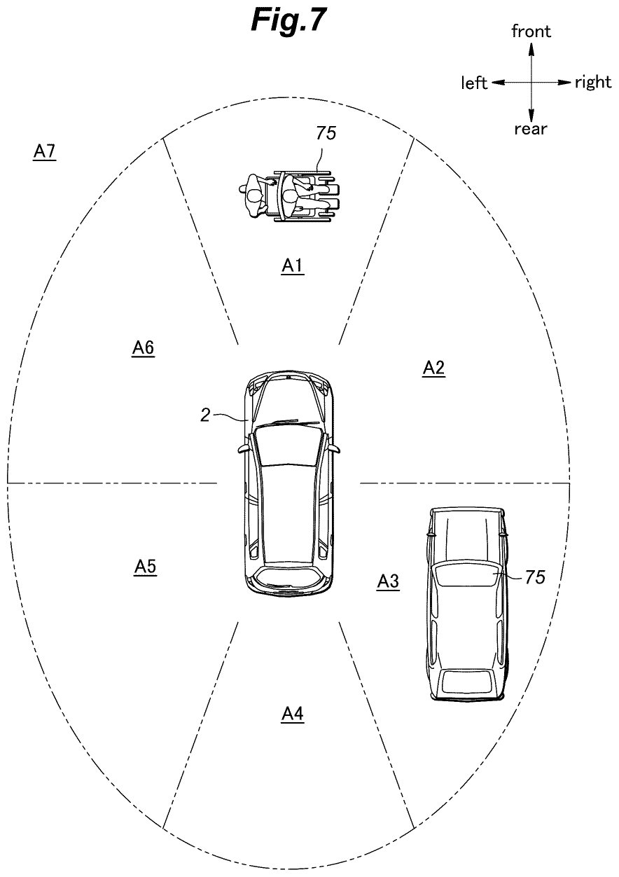

As shown in FIG. 1, a vehicle seat system includes at least one seat body 4 provided on a vehicle floor 3 of a vehicle 2, with one or more slide devices between the seat body and the vehicle floor (FIG. 7). The seat body 4 includes a seat cushion 5, a seatback 6 connected to a rear end of the seat cushion 5, and a headrest 7 provided at the top end of the seatback 6. The seat cushion 5 is configured to support the buttocks and thighs of a seated person from below. The seatback 6 is positioned behind a seated person's waist and back.

As shown in FIGS. 1, 2 and 5, the seat cushion 5 has a seat cushion frame 9, a seat cushion pad 10 supported by the seat cushion frame 9; and a first skin cover 11 provided to cover the outer surface of the seat cushion pad 10.

The seat cushion frame 9 is supported by the vehicle body to form a framework of the seat cushion 5. The seat cushion frame 9 includes a pair of side frames 12 spaced apart from each other and extending in a front-rear direction, a front frame 13 provided to connect front parts of the side frames 12, and a rear frame 14 provided to connect rear parts of the side frames 12. A plate-shaped pan frame 15 is provided to extend across the front frame 13 and the rear frame 14.

The pan frame 15 is a plate-shaped member with main surfaces facing upward and downward. The pan frame 15 is rectangular viewed from the above.

The seat cushion pad 10 is supported by and extends over the pan frame 15. The seat cushion pad 10 is a substantially rectangular-cuboid-shaped member which forms the seat cushion 5. The seat cushion pad 10 is made of foamed plastic such as urethane foam, which is elastically deformable. The seat cushion pad 10 has a cushion pad body 17, a lower cushion pad cover 18, and cushion pad side portions 19.

The cushion pad body 17 is configured to support the buttocks and thighs of a seated person from below. The lower surface of the cushion pad body 17 faces toward the pan frame 15 and constitutes the back surface of the seat cushion pad 10. The upper surface of the cushion pad body 17 forms a surface of the seat cushion pad 10. The cushion pad body 17 is covered by the first skin cover 11. The first skin cover 11 forms a seating surface of the seat body 4. A first draw-in groove 20 is formed on the top surface of the cushion pad body 17.

The first draw-in groove 20 is a groove which is recessed into the cushion pad body to the side of the pan frame 15. The first draw-in groove 20 comprises a plurality of grooves 21 extending in the front-rear direction and a plurality of lateral grooves 22 extending in the left-right direction. The plurality of grooves 21 are formed to be apart from each other, and the plurality of lateral grooves 22 are formed to be apart from each other. The first skin cover 11 is provided with hooks for hooking the first skin cover 11 to proper positions in the first draw-in groove 20.

A lower cushion pad cover 18 is plate-shaped and located on the front side of the cushion pad body 17. In the present embodiment, the lower cushion pad cover 18 is rectangular viewed from the above. The lower cushion pad cover 18 may be formed of the same material as the cushion pad body 17 or of a different material. The lower cushion pad cover 18 may be formed integrally with the cushion pad body 17. The lower cushion pad cover 18 has a first air passage groove 25 and first receiving recesses 26.

The first air passage groove 25 is a groove recessed downward from the top surface of the lower cushion pad cover 18. The first air passage groove 25 extends from the right rear edge of the lower cushion pad cover 18 and branches into two, extending to the left and right front edges. The first air passage groove 25 defines a flow path for directing air blown from the first air blowing unit in the seat cushion 5 toward the seating surface of the seat body 4. The first air passage groove 25 is connected to and in communication with the first air blowing unit through a through-hole formed in the cushion pad body 17.

The first receiving recesses 26 are recessed downward from the top surface of the lower cushion pad cover 18. The first receiving recesses 26 may or may not have a bottom. The first receiving recesses 26 may be provided at positions which do not overlap the first air passage groove 25, as viewed from the above. In the present embodiment, the first receiving recesses 26 are formed at four corners of the lower cushion pad cover 18. The two first receiving recesses 26 formed at the rear end of the lower cushion pad cover 18 may be formed to be aligned with each other in the front-rear and the vertical directions. The two first receiving recesses 26 formed at the front end in the lower cushion pad cover 18 may be formed to be aligned with each other in the front-rear and vertical directions. The first receiving recesses 26 accommodate first vibration devices 30, respectively.

Each of the first vibration devices 30 has a motor 31 for providing s vibration and a harness 32 (i.e. a bundle of wires) connected to the motor 31. The first vibration devices 30 provide stimulation to the buttocks and thighs of a seated person in the seat body 4, with vibration generated by the respective motors 31. Each motor 31 may be a known motor such as an eccentric motor or a linear motor.

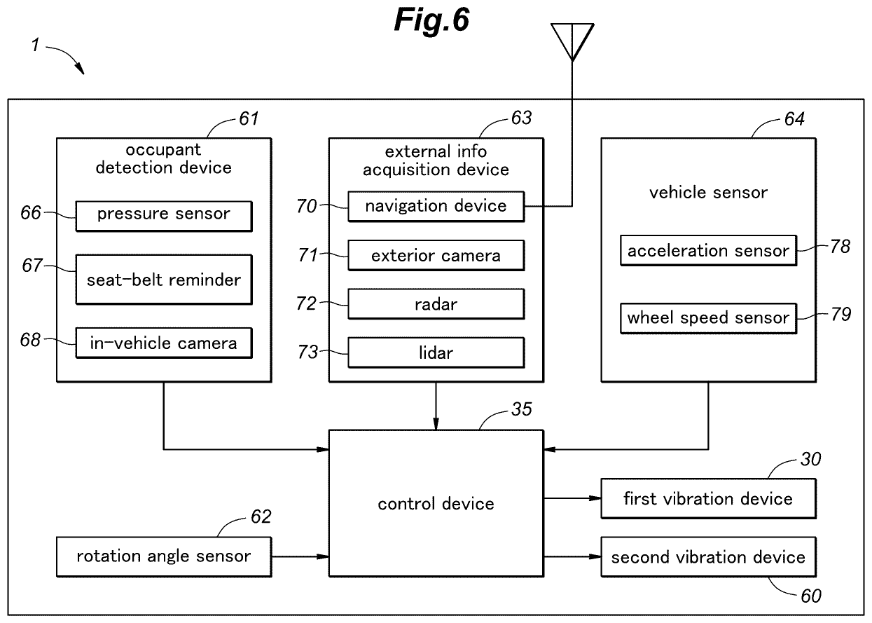

Each harness 32 is electrically connected to a motor 31 in a first vibration device. The harness 32 may be connected to the coil of the motor 31 at one end. The harness 32 may be connected at the other end to a control device 35 (FIG. 6) described later. The other end of the harness 32 may extend behind the seat body 4 through a gap between the seat cushion 5 and the seatback 6. The harness 32 may extend rearward of the seat body 4 through a through-hole formed in the bottom of the first receiving recess 26. Each harness 32 may extend rearward of the seat body 4 through a slit into the first draw-in groove 20, the slit being formed to extend from a corresponding first receiving recess 26 to the first draw-in groove 20.

In the present embodiment, four first vibration devices 30 are provided in the seat cushion 5. The first vibration devices 30 may be controlled by the control device 35 (FIG. 6) on a group-by-group basis, each group consisting of a plurality of first vibration devices 30 as described later. For example, the first vibration devices 30 may be grouped into two groups and controlled on a group-by-group basis, the two groups being a first set of vibration devices consisting of two first vibration devices 30 provided in a front end part of the seat cushion 5 (front first vibration devices), and a second set of vibration devices consisting of two first vibration devices 30 provided in a rear end part of the seat cushion 5 (rear first vibration devices).

An upper cushion pad cover (not shown) may be provided above the lower cushion pad cover 18. The upper cushion pad cover may be a plate-shaped member having main surfaces facing upward and downward. The upper cushion pad cover may define an air flow path extending within the first air passage groove 25.

The cushion pad side portions 19 are connected to the left and right sides of the cushion pad body 17. The cushion pad side portions 19 extend in the front-rear direction and project upward. The cushion pad side portions 19 support the buttocks and thighs of a seated person from both sides. The left and right cushion pad side portions 19 have respective first air passage bag accommodation spaces 37.

Each of two first air passage bag accommodation space 37 is a recess recessed outward from the inner surface of a corresponding cushion pad side portion 19 in the left-right direction. Each of the first air passage bag accommodation spaces 37 extends in the front-rear direction, and accommodates a first air passage bag 38.

Each of two first air passage bag 38 is a bag-like member configured to hold air inside. The first air passage bag 38 inflates when air is supplied and deflates when air is evacuated. The first air passage bag 38 extends in the front-rear direction within the air passage bag accommodation space. The first air passage bag 38 has an inlet at the rear end, the inlet being connected to a first air blowing unit for delivering air to the first air passage bag 38. The first air passage bag 38 has at least one outlet at the rear end for discharging air toward a seated person in the seat body 4. The two first air passage bags 38 may be provided at locations which overlap each other in the front-rear and the vertical directions.

As shown in FIGS. 1, 3 and 5, the seatback 6 includes a seatback frame 39, a seatback pad 40 supported by the seatback frame 39, and a second skin cover 41 covered on the outer surface of the seatback pad 40.

The seatback frame 39 forms a framework of the seatback 6. The seatback frame 39 is pivotably attached to the rear end of the seat cushion frame 9 at the lower end. The seatback frame 39 includes left and right side frames 42, which are spaced apart from each other and extend in the vertical direction, an upper frame 43, which connects the upper parts of the side frames 42, and a lower frame 44, which connects the lower parts of the side frames 42. Provided below the upper frame 43 is a cross frame 16, which connects the side frames 42. A plate-shaped pressure receiving member 45 is provided to extend across the upper frame 43 and the lower frame 44.

The pressure receiving member 45 is a plate-shaped member having main surfaces facing frontward and rearward. The pressure receiving member 45 is rectangular, as viewed from the front. Two cutouts 46A are formed in the upper left and right corners of the pressure receiving member 45. Two through holes 46B are formed in the lower part of the pressure receiving member 45.

The seatback pad 40 is supported by the pressure receiving member 45 from the rear. The seatback pad 40 is a substantially rectangular-cuboid-shaped member which forms the seatback 6. The seatback pad 40 is made of foamed plastic such as urethane foam, which is elastically deformable. The seatback pad 40 is capable of supporting the waist and back of a seated person from the rear. The seatback pad 40 has a back pad body 47 and back pad side portions 49.

The back pad body 47 is capable of supporting the waist and back of a seated person from the rear. The rear surface of the back pad body 47 faces the pressure receiving member 45 and forms the backside surface of the seatback pad 40. The front surface of the back pad body 47 forms a surface of the seatback pad 40. At least the front surface of the back pad body 47 is covered by the second skin cover 41. The second skin cover 41 forms a seating surface of the seat body 4. The front surface of the back pad body 47 has a second air passage bag accommodation space 57, a second draw-in groove 50, a second air passage groove 51, second receiving recesses 52, and slits 53.

The second air passage bag accommodation space 57 is a recess recessed rearward from the front surface of the back pad body 47. The second air passage bag accommodation space 57 is formed at the upper end of the back pad body 47 and at the center portion in the left-right direction. The second air passage bag accommodation space 57 accommodates a second air passage bag 58.

The second air passage bag 58 is a bag-like member configured to hold air inside. The second air passage bag 58 inflates when air is supplied and deflates when air is evacuated. The second air passage bag 58 has an inlet on the rear side connected to a second air blowing unit for delivering air to the second air passage bag 58. The second air passage bag 58 has at least one outlet on the front side for discharging air toward a seated person in the seat body 4.

The second draw-in groove 50 is a groove which is recessed into the back pad body 47 on the side of the pressure receiving member 45. The second draw-in groove 50 has a U-shaped groove section viewed from the front and lateral groove section 55 extending in the left-right direction. The U-shaped groove section has two U-shaped vertical groove sections 54A on both sides, each extending in the vertical direction, and a lateral groove section 54B extending in the left-right direction which connects the upper ends of the two U-shaped vertical groove sections 54A. The two U-shaped vertical groove sections 54A are formed spaced apart from each other. The U-shaped lateral groove section 54B is located above and spaced apart from the lateral groove section 55. The second skin cover 41 is provided with hooks (not shown) for hooking the second skin cover 41 to proper positions in the second draw-in groove 50.

The second air passage groove 51 is a groove recessed rearward from the top surface of the back pad body 47. The second air passage groove 51 extends from the right rear edge of the back pad body 47 across the entire back pad body 47. The second air passage groove 51 defines a flow path for directing air blown from the second air blowing unit in the seatback 6 toward the seating surface of the seat body 4 through a connecting pipe 56.

Each of the second receiving recesses 52 is a recess recessed rearward from the front surface of the back pad body 47. The second receiving recesses 52 may or may not have a bottom. The second receiving recesses 52 may be formed below the lateral groove section 55 in the back pad body 47 and between the two U-shaped vertical groove sections 54A. The second receiving recesses 52 are preferably provided so as not to overlap the second air passage grooves 51, as viewed from the front. In the present embodiment, the two second receiving recesses 52 are formed at positions which correspond to the back of a seated person (i.e., in the center of the back pad body 47 in the vertical direction). In other words, the two second receiving recesses 52 are formed at positions which correspond to the lower back of a seated person (i.e., at the lower end of the back pad body 47).

The two second receiving recesses 52 formed at the center of the back pad body 47 in the vertical direction may be formed to be aligned with each other in the front-rear and the vertical directions. The two lower second receiving recesses 52 formed at the lower end part of the seatback 6 are preferably formed at positions inward in the left-right direction, as compared to the two upper second receiving recesses 52 formed in the center in the vertical direction.

The two second receiving recesses 52 formed at the vertical center are formed at positions corresponding to the two cutouts 46A, respectively, as viewed from the front. The two second receiving recesses 52 formed at the lower end are formed at positions corresponding to the two through holes 46B, respectively, as viewed from the front. The second receiving recesses 52 accommodates second vibration devices 60, respectively. As a result, the second vibration devices 60 are provided at positions frontward of the pressure receiving member 45, where the second vibration devices 60 do not overlap the pressure receiving member 45, as viewed from the front.

Each of the slits 53 is a recess recessed rearward from the front surface of the back pad body 47. Each slit 53 may be connected to the bottom or a side of a corresponding second receiving recess 52 and extend downward or laterally outward. Each slit 53 may or may not have a bottom. When the second receiving recess 52 does not have a bottom, the slit 53 may be omitted.

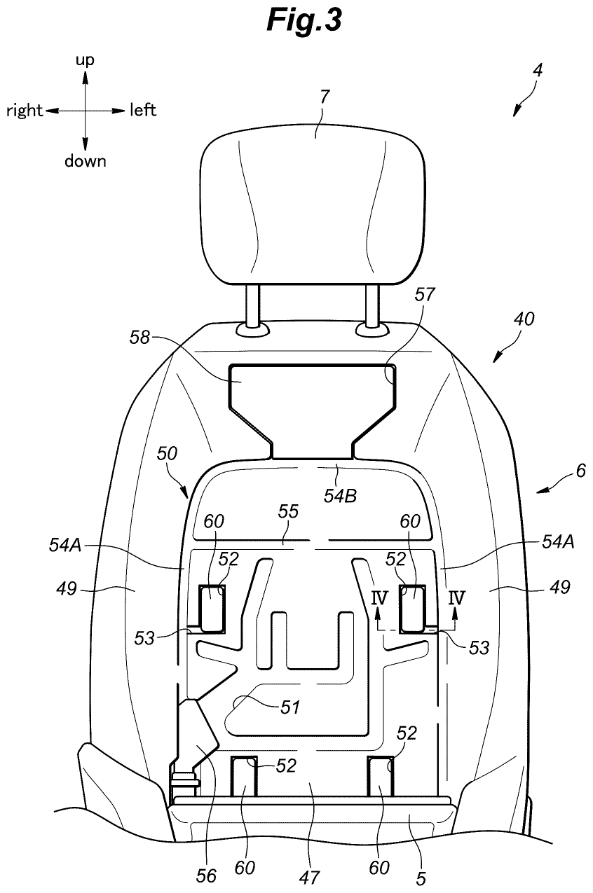

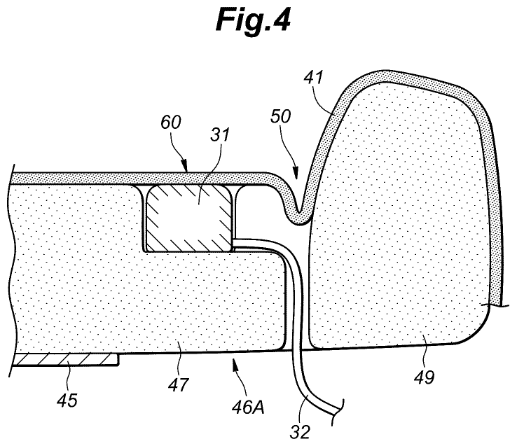

As shown in FIGS. 3 and 4, each second vibration device 60 has the same configuration as a first vibration device 30. Each second vibration device 60 has a harness 32 which is connected to the coil of a motor 31 at one end. The harness 32 of the second vibration device 60 may extend through a gap between the seat cushion 5 and the seatback 6 to the rear of the seat body 4. Each harness 32 may extend through a corresponding slit 53 and within the second draw-in groove 50.

In the present embodiment, four second vibration devices 60 are provided in the seatback 6. The second vibration devices 60 may be controlled by the control device 35 (FIG. 6) on a group-by-group basis, each group comprising a plurality of second vibration devices 60 as described later. For example, the second vibration devices 60 may be grouped into two groups and controlled on a group-by-group basis, the two groups being a third set of vibration devices consisting of two second vibration devices 60 provided in a lower end part of the seatback 6 (lower second vibration devices), and a fourth set of vibration devices consisting of two second vibration devices 60 provided in an upper end part of the seatback 6 (upper second vibration devices).

A back pad cover (not shown) may be provided frontward of the back pad body 47. The back pad cover may be a plate-shaped member having main surfaces facing frontward and rearward. The back pad cover may define an air flow path extending within the second air passage groove 51.

The back pad side portions 49 are connected to the left and right sides of the back pad body 47. The back pad side portions 49 extend in the vertical direction and project frontward. The back pad side portions 49 support the body of a seated person from both sides.

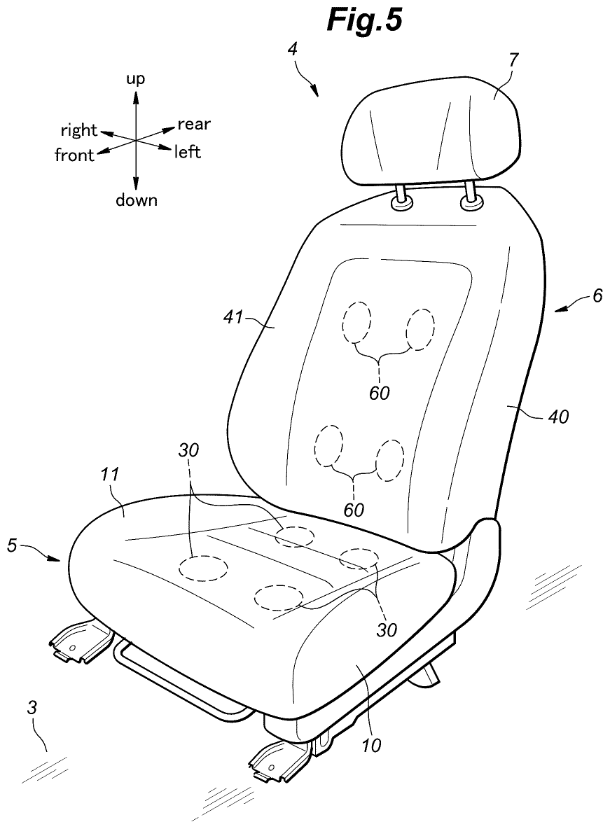

As shown in FIGS. 5 and 6, the control device 35 is an electronic control device (ECU) including a CPU. ROM, and RAM. In the control device 35, the CPU performs arithmetic processes according to programs to execute various control operations. The control device 35 may be configured as a single piece of hardware or as a unit comprising multiple pieces of hardware.

The control device 35 is connected to the first vibration devices 30 and the second vibration devices 60, and also to an occupant detection device 61, a rotation angle sensor 62, an external information acquisition device 63, and a vehicle sensor 64. The control device 35 controls the first vibration devices 30 and the second vibration devices 60 according to information acquired from the occupant detection device 61, the rotation angle sensor 62, the external information acquisition device 63, and the vehicle sensor 64.

The occupant detection device 61 detects whether an occupant is seated in the seat body 4. The occupant detection device 61 may comprise, for example, a pressure sensor 66, a seat belt reminder 67, an in-vehicle camera 68, and other components.

In detecting the rotation angle of the seat body 4 by the rotation angle sensor 62, the rotation angle when the seat body 4 is facing frontward of the vehicle 2 (FIG. 7) may be defined as zero degree (hereinafter referred to as the initial position). In detecting the rotation angle of the seat body 4 by the rotation angle sensor 62, the rotation angle when the seat body 4 rotates 180 degrees clockwise and counterclockwise from the initial position, may be defined as +180 degrees and −180 degrees, respectively.

The control device 35 may determine the orientation of the seat body 4 based on the detection result of the rotation angle sensor 62. For example, the control device 35 may determine that the seat body 4 is facing rearward when the absolute value of the rotation angle of the seat body 4 is greater than a predetermined threshold value. Specifically, the control device 35 may determine that the seat body 4 is facing rearward when the detection result of the rotation angle sensor 62 is equal to or less than −90 degrees or more than 90 degrees.

The external information acquisition device 63 acquires external information, which is information external to the vehicle 2 (FIG. 7), and transmits the acquired external information as signals to the control device 35. The external information acquisition device 63 may have any information acquisition means, such as a navigation device 70 or an external camera 71, or any sensor such as a radar 72 or a lidar 73.

As shown in FIGS. 6 and 7, the control device 35 detects an object 75 which is present outside of the vehicle 2 based on signals from the external information acquisition device 63. The object 75 may be an object that may obstruct the travel of the vehicle 2 or that may be dangerous to the travel of the vehicle 2. Examples of the objects 75 may include other vehicles, obstacles, and persons.

The control device 35 acquires information as to in which of first areas A1 to sixth area A6 the object 75 is present based on signals from the external information acquisition device 63. The first area A1 is an area frontward of the vehicle 2. The second area A2 is an area frontward and rightward of the vehicle 2. The third area A3 is an area rearward and rightward of the vehicle 2. The fourth area A4 is an area rearward of the vehicle 2. The fifth area A5 is an area rearward and leftward of the vehicle 2. The sixth area A6 is an area frontward and leftward of the vehicle 2. When the object 75 is not in any of the areas A1 to A6, the control device 35 determines that the object 75 is in the seventh area A7.

The region of each area may be determined as appropriate. For example, the region of each of the first area A1 and the fourth area A4 may be determined to be broader than that of each of the other areas.

The vehicle sensor 64 acquires the driving status of the vehicle 2. The vehicle sensor 64 comprises an acceleration sensor 78 and a wheel speed sensor 79. The acceleration sensor 78 detects the acceleration of the vehicle 2. The wheel speed sensor 79 detects the rotation speed of the wheels.

Next, a vibration operation of the vehicle seat system 1 will be described. When the vehicle 2 is turned on, the control device 35 performs the following vibration operation at predetermined intervals.

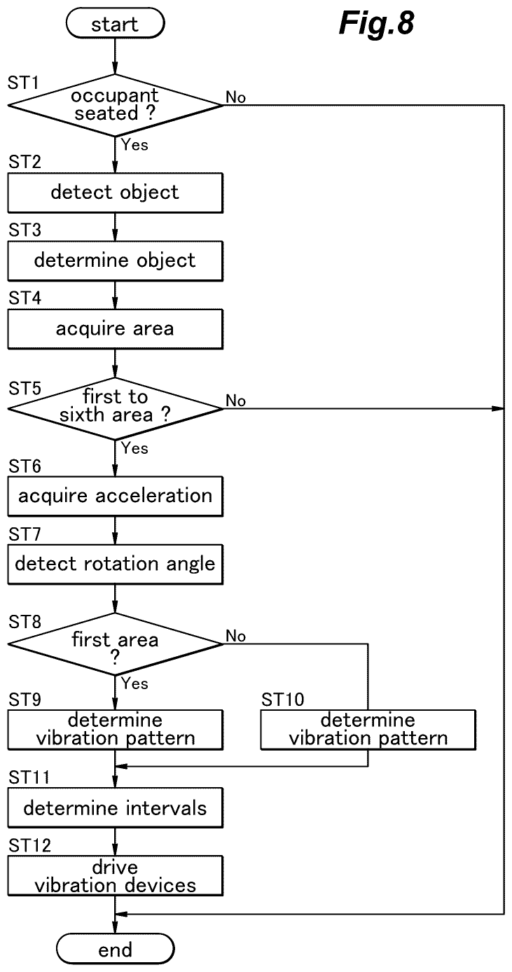

As shown in FIG. 8, first, the control device 35 determines whether or not an occupant is seated in the seat body 4 based on the detection results of the occupant detection device 61 (ST1).

When determining that an occupant is seated in the seat body 4 (Yes in ST1), the control device 35 detects the object 75 (ST2). When determining that the occupant is not seated in the seat body 4 (No in ST1), the control device 35 terminates the vibration operation.

In ST2, the control device 35 may acquire the distance between the vehicle 2 and the object 75 and the direction of the object 75 relative to the vehicle 2 based on external information from the external information acquisition device 63. After ST2 is completed, the control device 35 determines the target object 75 (ST3).

In ST3, the control device 35 determines the target object 75 from objects detected in ST2. When detecting only one object 75 in ST2, the control device 35 determines the detected object 75 as the target object 75. When detecting a plurality of objects 75 in ST2, the control device 35 determines one of the detected objects as the target object 75.

The control device 35 may determine the object with the shortest distance from the vehicle 2 as the target object 75. The control device 35 may, for example, determine the target object 75 based on the speeds of movement of the vehicle 2 and the object 75. The control device 35 may determine the target object 75, for example, by weighting a plurality of evaluation items (e.g., the distance or direction from the vehicle 2 to the object 75, the speed of the object 75 or the size of the object 75). After ST3 is completed, the control device 35 acquires an area in which the target object 75 is present (ST4).

In ST4, the control device 35 may determine whether the target object 75 is present in any of the areas A1 to A6 based on the distance between the vehicle 2 and the object 75 and the direction of the object 75 relative to the vehicle 2. After ST4 is completed, the control device 35 determines whether the subject object 75 is present in any of the areas A1 to A6 (ST5).

When determining that the target object 75 is in one of the areas A1 to A6 (Yes in ST5), the control device 35 acquires the acceleration of the vehicle 2 detected by the acceleration sensor 78 (ST6) and acquires the rotation angle of the seat body 4 detected by the rotation angle sensor 62 (ST7). After ST7 is completed, the control device 35 determines whether the area in which the target object 75 is present is the first area A1 (ST8).

When determining that the target object 75 is not present in any of areas 1A1 to 6A6 (No in ST5), the control device 35 determines that the target object 75 is in the seventh area A7 and terminates the vibration operation.

When determining that the area in which the target object 75 is present is the first area A1 (Yes in ST8), the control device 35 determines the vibration patterns of the first vibration device 30 and the second vibration device 60 (S9).

In ST9, the control device 35 determines a vibration pattern based on the acceleration acquired in ST6 and the rotation angle acquired in ST7. Specifically, when determining that the acceleration is equal to or less than a predetermined threshold value A (A<0) and the absolute value of the rotation angle is less than a predetermined threshold value B, the control device 35 determines the vibration pattern to be a both-side first vibration pattern, in which the control device 35 causes the plurality of the first vibration devices 30 on both right and left sides of the seat body 4 to vibrate in order of the front first vibration devices in the front end part of the seat cushion 5, and the rear first vibration devices in the rear end part of the seat cushion 5, and then causes the plurality of the second vibration devices 60 on both right and left sides of the seat body 4 in order of the lower second vibration devices in the lower end part of the seatback 6 and the upper second vibration devices in the upper end part of the seatback 6.

When determining that the acceleration is equal to or less than the predetermined threshold value A and the absolute value of the rotation angle is equal to or greater than the predetermined threshold value B, the control device 35 determines the vibration pattern to be a both-side second vibration pattern, in which the control device 35 causes the plurality of the second vibration devices 60 on both right and left sides of the seat body 4 to vibrate in order of the upper second vibration devices and the lower second vibration devices in the seatback 6, and then causes the plurality of the first vibration devices 30 on both right and left sides of the seat body 4 in order of the rear first vibration devices and the front first vibration devices in the seat cushion 5.

When determining that the acceleration is equal to or greater than the predetermined threshold value A and the absolute value of the rotation angle is less than the predetermined threshold value B, the control device 35 may determine the vibration pattern to be a both-side third vibration pattern, in which the control device 35 causes the first and second vibration devices to vibrate in the both-side first vibration pattern and then in both-side second vibration pattern.

When determining that the acceleration is equal to or greater than the predetermined threshold value A and the absolute value of the rotation angle is equal to or greater than the predetermined threshold value B, the control device 35 may determine the vibration pattern to be a both-side fourth vibration pattern, in which the control device 35 causes the first and second vibration devices to vibrate in the both-side second vibration pattern and then in both-side first vibration pattern.

After ST9 is completed, the control device 35 determines the vibration intervals at which the control device 35 causes the first vibration device 30 and the second vibration device 60 to vibrate (ST11).

When determining that the area in which the target object 75 is present is not the first area A1 (No in ST8), the control device 35 determines the vibration pattern of the first vibration devices 30 and the second vibration devices 60 (ST10).

In ST10, the control device 35 determines the vibration pattern based on information about the area acquired in ST4 and the rotation angle acquired in ST7.

Specifically, when determining that the target object 75 is present in the second area A2 and the absolute value of the rotation angle is less than the predetermined threshold value B, the control device 35 determines the vibration pattern to be a right-side first vibration pattern, in which the control device 35 causes the plurality of the first vibration devices 30 on the right of the seat body 4 to vibrate in order of the front first vibration device(s) and the rear first vibration device(s) in the seat cushion 5, and then causes the plurality of the second vibration devices 60 on the right side of the seat body 4 in order of the lower second vibration device(s) and the upper second vibration device(s) in the seatback 6.

When determining that the target object 75 is present in the second area A2 and the absolute value of the rotation angle is equal to or greater than the predetermined threshold value B, the control device 35 determines the vibration pattern to be a left-side second vibration pattern, in which the control device 35 causes the plurality of the second vibration devices 60 on the left side of the seat body 4 to vibrate in order of the upper second vibration device(s) and the lower second vibration device(s) in the seatback 6, and then causes the plurality of the first vibration devices 30 on the left side of the seat body 4 in order of the rear first vibration device(s) and the front first vibration device(s) in the seat cushion 5.

When determining that the target object 75 is present in the third area A3 and the absolute value of the rotation angle is less than the predetermined threshold value B, the control device 35 determines the vibration pattern to be a right-side second vibration pattern, in which the control device 35 causes the plurality of the second vibration devices 60 on the right side of the seat body 4 to vibrate in order of the upper second vibration device(s) 60 and the lower second vibration device(s) in the seatback 6, and then causes the plurality of the first vibration devices 30 on the right side of the seat body 4 in order of the rear first vibration device(s) and the front first vibration device(s) in the seat cushion 5.

When determining that the target object 75 is present in the third area A3 and the absolute value of the rotation angle is equal to or greater than the predetermined threshold value B, the control device 35 determines the vibration pattern to be a left-side first vibration pattern, in which the control device 35 causes the plurality of the first vibration devices 30 on the left side of the seat body 4 to vibrate in order of the front first vibration device(s) and the rear first vibration device(s) in the seat cushion 5, and then causes the plurality of the second vibration devices 60 on the left side of the seat body 4 in order of the lower second vibration devices and the upper second vibration devices in the seatback 6.

When determining that the target object 75 is present in the fourth area A4 and the absolute value of the rotation angle is less than the predetermined threshold value B, the control device 35 determines the vibration pattern to be the both-side second vibration pattern. When determining that the target object 75 is present in the fourth area A4 and the absolute value of the rotation angle is equal to or greater than the predetermined threshold value B, the control device 35 determines the vibration pattern to be the both-side first vibration pattern.

When determining that the target object 75 is present in the fifth area A5 and the absolute value of the rotation angle is less than the predetermined threshold value B, the control device 35 determines the vibration pattern to be the left-side second vibration pattern.

When determining that the target object 75 is present in the fifth area A5 and the absolute value of the rotation angle is equal to or greater than the predetermined threshold value B, the control device 35 determines the vibration pattern to be the right-side first vibration pattern.

When determining that the target object 75 is present in the sixth area A6 and the absolute value of the rotation angle is less than the predetermined threshold value B, the control device 35 determines the vibration pattern to be the left-side first vibration pattern.

When determining that the target object 75 is present in the sixth area A6 and the absolute value of the rotation angle is equal to or greater than the predetermined threshold value B, the control device 35 determines the vibration pattern to be the right-side second vibration pattern.

After ST10 is completed, the control device 35 determines the vibration intervals at which the control device 35 causes the first vibration device 30 and the second vibration device 60 to vibrate (ST11).

In ST11, the control device 35 may determine the vibration intervals of the first vibration devices 30 and the second vibration devices 60 as a value obtained by multiplying the distance between the vehicle 2 and the object 75 acquired in ST2 by a predetermined factor α (α>0). In the present embodiment, the vibration interval refers to the time from the start of driving one of the first vibration devices 30 and the second vibration devices 60 to the start of driving another one of the first vibration devices 30 and the second vibration devices 60. After ST11 is completed, the control device 35 drives the first vibration devices 30 and the second vibration devices 60 (ST12).

In ST12, the control device 35 causes the first vibration devices 30 and the second vibration devices 60 to vibrate in order at certain vibration intervals based on the vibration pattern determined in ST9 or ST10 and the vibration intervals determined in ST11. The control device 35 may cause the first vibration devices 30 and the second vibration device 60 to vibrate only once or repeatedly multiple times in the determined vibration pattern and at the vibration intervals. When ST12 is completed, the control device 35 terminates the vibration operation.

Next, the effects achieved by the vehicle seat system 1 will be described. The vehicle seat system 1 comprises: a seat body 4 mounted on a vehicle 2, the seat body having a seat cushion 5 and a seatback 6; an external information acquisition device 63 for acquiring external information, which is information external to the vehicle 2; one or more first vibration devices 30 provided in the seat cushion 5; one or more second vibration devices 60 provided in the seatback 6; and a control device configured to control the first vibration devices 30 and the second vibration devices 60 according to the external information. The control device 35 is configured to cause one of the first and second vibration devices 30, 60 to vibrate, followed by causing the other of the first and second vibration devices 30, 60 to vibrate.

In this configuration, the system causes one of the first and second vibration devices 30 and 60 in the seat cushion 5 and the seatback 6 to vibrate, followed by causing the other of the first and second vibration devices 30 and 60 to vibrate based on external information. As a result, the vibration is transmitted in order to the buttocks and thighs and the back and waist of a seated person. Thus, since the first vibration devices 30 and the second vibration devices 60, which are provided in two locations spaced apart from each other, vibrate in order, the system can effectively notify an occupant of information external to a vehicle 2.

The seat body 4 may be configured such that the first vibration devices 30 comprise one or more front first vibration devices located in a front part of the seat cushion and one or more rear first vibration devices located in a rear part of the seat cushion, and that the second vibration devices 60 comprise one or more upper second vibration devices located in an upper part of the seatback and one or more lower second vibration devices located in a lower part of the seatback. The control device 35 causes the first vibration devices 30 and the second vibration devices 60 to vibrate in the first vibration pattern or second vibration pattern. In the first vibration pattern, the control device 35 causes the first vibration devices to vibrate in order from the front first vibration devices 30 to the rear vibration devices 30, and then causes the second vibration devices 60 to vibrate in order from the lower second vibration devices to the upper second vibration devices. In the second vibration pattern, the control device 35 causes the second vibration devices to 60 vibrate in order from the upper second vibration devices to the lower second vibration devices, and then causes the first vibration devices 30 to vibrate in order from the rear first vibration devices to the front first vibration devices.

In this configuration, the first vibration devices 30 and the second vibration devices 60 vibrate in order from front to rear or vice versa and in order from bottom to top or vice versa. This enables a larger vibration area in the seat body, thereby ensuring that the system effectively notifies an occupant of external information i.e., information external to the vehicle 2.

In some cases, when determining, based on the external information, that an object 75 is present frontward of the vehicle 2, the control device 35 causes the first and second vibration devices 30, 60 to vibrate in the first vibration pattern, whereas, when determining that an object is present rearward of the vehicle 2, the control device 35 causes the first and second vibration devices 30, 60 to vibrate in the second vibration pattern.

In this configuration, when determining that an object 75 is present frontward of the vehicle, one or more first vibration devices 30 vibrate in order from front to rear, and then one or more second vibration devices 60 vibrate in order from bottom to top. When determining that an object 75 is present rearward of the vehicle 2, one or more second vibration devices 60 vibrate in order from top to bottom in the seatback 6, and then one or more first vibration devices 30 vibrate in order from rear to front in the seat cushion 5. Thus, since the direction in which the object 75 is present as seen from the vehicle 2 is the same as the direction in which the vibration devices begin to vibrate in order, the system can intuitively notify an occupant of the presence of an object 75 outside.

In some cases, the control device 35 causes the first and second vibration devices 30, 60 to vibrate in order, at predetermined intervals, and changes the intervals based on the external information. In this configuration, the control device 35 can clearly notify an occupant in the vehicle 2 of external information by changing the vibration intervals between the first and second vibration devices 30, 60.

In some cases, the control device 35 changes the intervals based on the external information such that the closer the distance between the vehicle and the object is, the shorter the intervals. In this configuration, the system can effectively notify an occupant that the distance between the vehicle 2 and the object 75 is close.

In some cases, the vehicle seat system 1 further comprises an occupant detection device 61 for detecting that an occupant is seated in the seat body 4. When determining, based on a signal from the occupant detection device 61, that an occupant is not seated in the seat body 4, the control device 35 prohibits the first and second vibration devices 30 and 60 from vibrating. In this configuration, when an occupant is not seated in the seat body 4, the system can prevent unnecessary vibration of the first vibration devices 30 and the second vibration devices 60. As a result, generation of vibration noise is reduced.

In some cases, the vehicle seat system 1 further comprises a rotation angle sensor 62 for detecting a rotation angle of the seat body 4. In a case where an object 75 is present frontward of the vehicle, when the rotation angle is less than a predetermined threshold value, the control device 35 determines that the seat body is facing frontward and causes the first vibration devices 30 to vibrate, followed by causing the second vibration devices 60 to vibrate whereas, when the rotation angle is equal to and greater than the predetermined threshold value, the control device 35 determines that the seat body 4 is facing rearward and causes the second vibration devices 60 to vibrate, followed by causing the first vibration devices 30 to vibrate.

In this configuration, when the seat body 4 faces rearward and an object 75 is present frontward of the vehicle 2, the order of vibration of the first vibration devices 30 and the second vibration devices 60 is a reverse of the order when the seat body 4 faces frontward, which enables the direction in which the object 75 is present as seen from the vehicle 2 to be the same as the direction in which the vibration devices begin to vibrate in order in the seat body 4. As a result, even when the seat body 4 is facing rearward, the system can intuitively inform an occupant in the vehicle 2 of the external information.

In some cases, the vehicle seat system 1 further comprises a pressure receiving member 45 with main surfaces facing frontward and rearward of the seat body 4, where the pressure receiving member is configured to receive a pressure applied from a body of an occupant seated in the seat body 4. The second vibration devices 60 are provided frontward of, and not overlapping with the pressure receiving member 45 viewed in the front-rear direction.

In this configuration, when the vehicle 2 is hit from behind, the second vibration devices 60 are prevented from being pushed frontward by the pressure receiving member 45. As a result, when the vehicle 2 is hit from behind, the second vibration devices 60 are prevented from interfering with the occupant.

In some cases, when determining the vibration pattern to be the both-side first vibration pattern, the control device 35 causes the first and second vibration devices 30, 60 to vibrate on a group-by-group basis, in order of the first set of vibration devices, the second set of vibration devices, the third set of vibration devices, and the fourth set of vibration devices. When determining the vibration pattern to be the both-side second vibration pattern, the control device 35 causes the first and second vibration devices 30, 60 to vibrate in order of the fourth set of vibration devices, the third set of vibration devices, the second set of vibration devices, and the first set of vibration devices.

In this configuration, the first and second vibration devices 30, 60 are grouped into groups each comprising the first and second vibration devices 30 or 60, and are caused to vibrate on a group-by-group basis, which allows the first or second vibration devices 30 or 60 of each group to vibrate simultaneously. This increases the area in the seat body 4 over which vibrations are transmitted simultaneously, which ensures that the system notifies an occupant in the vehicle 2 of external information.

In a first variant of the first embodiment, the control device 35 may determine, in ST11, the vibration intensity of the first vibration devices 30 and the second vibration device 60 a value obtained by multiplying the distance between the vehicle 2 and the object 75 acquired in ST2 by a predetermined factor β (β>0). In other words, the control device 35 may determine the vibration intensity of the first vibration devices 30 and the second vibration devices 60 such that the closer the distance between the vehicle 2 and the object 75 is, the stronger the vibration intensity is. In this configuration, the vibration intensity of the first vibration devices 30 and the second vibration devices 60 can be used to notify an occupant of the distance between the vehicle 2 and another vehicle.

In a second variant of the first embodiment, the control device 35 may determine, in ST9, the vibration pattern based on whether or not a collision mitigation brake system (automatic brake system) in the vehicle 2 is activated, instead of the acceleration. Specifically, when determining that the collision mitigation brake system is activated and the absolute value of the rotation angle is less than the predetermined threshold value B, the control device 35 determines the vibration pattern to be the both-side first vibration pattern. When determining that the collision mitigation brake system is activated and the absolute value of the rotation angle is equal to or greater than the predetermined threshold value B, the control device 35 determines the vibration pattern to be the both-side second vibration pattern. When determining that the collision mitigation brake system is not activated and the absolute value of the rotation angle is equal to or greater than the predetermined threshold value B, the control device 35 determines the vibration pattern to be the fourth vibration pattern. In this case, vibration patterns are enabled to be determined with a simple configuration.

### Second Embodiment

A vehicle seat system 1 of the second embodiment of the present invention is different from the first embodiment in that the control device 35 is configured to perform a vibration operation when detecting that the vehicle 2 is approaching a point where the vehicle 2 needs to make a change of direction (direction-change point) based on information acquired from a navigation device 70. In the description of the second embodiment, the same features or elements as those of the first embodiment are denoted with same reference numerals without repeating the description thereof.

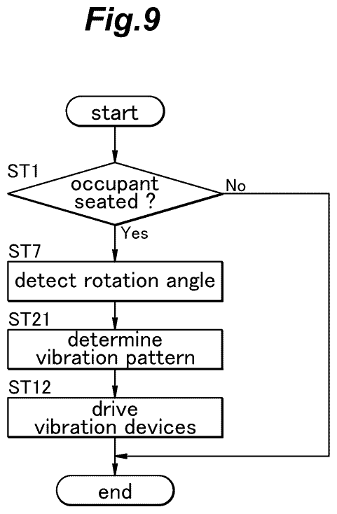

As shown in FIG. 9, in ST1, the control device 35 determines whether or not an occupant is seated in the seat body 4 based on the detection results of the occupant detection device 61 (ST1).

When determining that an occupant is seated in the seat body 4 (Yes in ST1), the control device 35 acquires the rotation angle of the seat body 4 detected by the rotation angle sensor 62 (ST7) and determines the vibration pattern (ST21). When determining that an occupant is not seated in the seat body 4 (No in ST1), the control device 35 terminates that the vibration operation.

In ST21, the control device 35 determines the vibration pattern based on the information acquired from navigation device 70 and the rotation angle acquired in ST7.

Specifically, when detecting that the vehicle 2 is approaching a point where the vehicle needs to turn right (hereinafter referred to as “right turn point”) and determining that the seat body 4 is facing frontward, the control device 35 determines the vibration pattern to be the right side first vibration pattern.

When detecting that the vehicle 2 is approaching a right turn point and determining that the seat body 4 is facing rearward, the control device 35 determines the vibration pattern to be the left side second vibration pattern.

When detecting that the vehicle 2 is approaching a point where the vehicle needs to turn left (hereinafter referred to as “left turn point”) and determining that the seat body 4 is facing frontward, the control device 35 determines the vibration pattern to be the left side first vibration pattern.

When detecting that vehicle 2 is approaching a left turn point and determining that the seat body 4 is facing rearward, the control device 35 determines the vibration pattern to be the right side second vibration pattern.

When ST21 is completed, the control device 35 causes the first vibration devices 30 and the second vibration devices 60 to vibrate in the vibration pattern determined in ST21 (ST12). When ST12 is completed, the control device 35 terminates the vibration operation.

According to this configuration, the system can notify an occupant that the vehicle 2 is approaching a direction-change point based on external information acquired from the navigation device 70.

In a first variant of the second embodiment, the control device 35 may determine that the vibration pattern in ST21 as follows. That is, when detecting that the vehicle 2 is approaching a right turn point and determining that the seat body 4 is facing frontward, the control device 35 determines the vibration pattern to be the right side second vibration pattern. When detecting that vehicle 2 is approaching a right turn point and determining that the seat body 4 is facing rearward, the control device 35 determines the vibration pattern to be the left-side first vibration pattern. When detecting that vehicle 2 is approaching a left turn point and determining that the seat body 4 is facing frontward, the control device 35 determines the vibration pattern to be the left-side second vibration pattern. When detecting detects that the vehicle 2 is approaching a left turn point and determining that the seat body 4 is facing rearward, the control device 35 determines the vibration pattern to be the right side first vibration pattern.

In a second variant of the second embodiment, in ST21, when detecting that the vehicle 2 is approaching a right turn point and determining that the seat body 4 is facing frontward and when detecting that vehicle 2 is approaching a left turn point and determining that the seat body 4 is facing rearward, the control device 35 may cause the first vibration devices 30 and the second vibration devices 60 on the right side of the seat body 4 to vibrate simultaneously. In ST21, when detecting that the vehicle 2 is approaching a right turn point and determining that the seat body 4 is facing rearward, and when detecting that vehicle 2 is approaching a left turn point and determining that the seat body 4 is facing frontward, or when detecting that vehicle 2 is approaching a left turn point and determining that the seat body 4 is facing frontward, the control device 35 may cause the first vibration devices 30 and the second vibration devices 60 on the left side of the seat body 4 to vibrate simultaneously.

In this configuration, since a plurality of first vibration devices 30 or a plurality of second vibration devices 60 vibrate simultaneously, the system effectively notifies an occupant that a direction-change point is approaching.

Specific embodiments of the present invention are described above. However, those embodiments are non-limiting, and various modifications may be made to the embodiments without departing from the scope of the present invention. The system may be configured to use an in-vehicle camera 68, instead of the rotation angle sensor 62, to determine whether or not the seat body 4 is facing rearward. The second receiving recesses 52 may be provided so as to overlap the pressure receiving member 45 as viewed from the front, so that the pressure receiving member 45 reduces the vibration noise of the second vibration devices 60 housed in the second receiving recesses 52. The control device 35 may use the detection results of the wheel speed sensor 79 to determine the vibration pattern.

When the vehicle 2 is about to start frontward from a stop and the seat body 4 is facing frontward with an object 75 present in the first area A1, the control device 35 may cause the first vibration devices 30 to vibrate. In this case, the control device 35 preferably causes all the first vibration devices 30 to vibrate simultaneously. In some cases, the control device 35 may cause the first set of vibration devices and the second set of vibration devices to vibrate in an alternate manner. Furthermore, when the vehicle is not in gear to go toward the object 75 (i.e., frontward), the control device 35 may prohibit the first vibration devices 30 from vibrating.

When the vehicle 2 is about to start rearward from a stop and the seat body 4 is facing frontward with an object 75 present in the fourth area A4, the control device 35 may cause the second vibration devices 60 to vibrate. In this case, the control device 35 preferably causes all the second vibration devices 60 to vibrate simultaneously. In some cases, the control device 35 may cause the third set of vibration devices and the fourth set of the vibration devices to vibrate in an alternate manner. Furthermore, when the vehicle is not in gear to go toward the object 75 (i.e., rearward), the control device 35 may prohibit the second vibration devices 60 from vibrating.

When a right-turn indicator of the vehicle 2 is activated and the seat body 4 is facing frontward with another vehicle as an object 75 present in the second area A2 or the third area A3, the control device 35 may cause the first vibration devices 30 on the right side and the second vibration devices 60 on the right side simultaneously. Similarly, when a left-turn indicator of the vehicle 2 is activated and the seat body 4 is facing frontward with another vehicle as an object 75 present in the fifth area A5 or the sixth area A6, the control device 35 may cause the first vibration devices 30 on the left side and the second vibration devices 60 on the left side simultaneously.

### Third Embodiment

Next, a third embodiment of a vehicle seat system according to the present invention will be described. In the following description, the front/rear, left/right, and vertical directions are defined relative to a person seated in a vehicle seat (seated person or occupant).

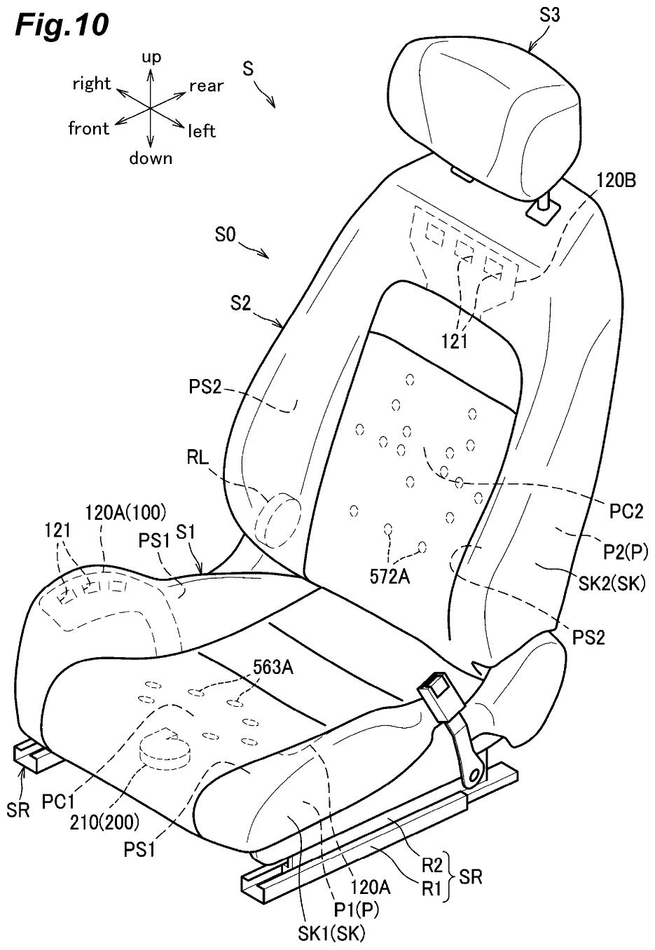

As shown in FIG. 10, a vehicle seat of this embodiment is configured as a vehicle seat S to be installed in a motor vehicle as a vehicle. The vehicle seat S is equipped with a seat body S0 in which a person is seated, a temperature control device 100, and an air conditioning device 200.

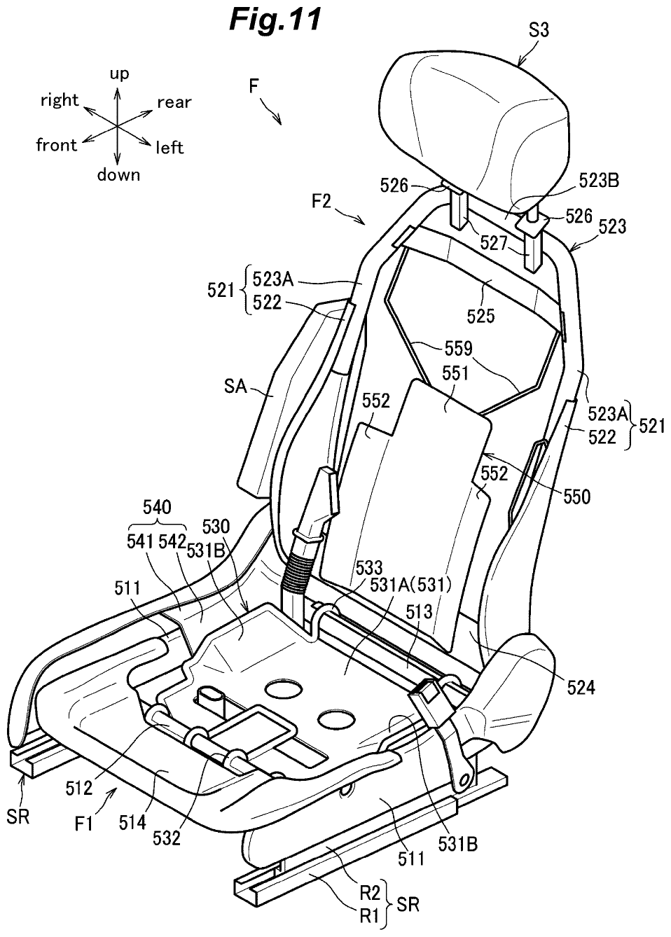

The seat body S0 includes a seat cushion S1, a seatback S2, and a headrest S3. The vehicle seat S is further provided with a reclining mechanism RL that rotatably connects the seatback S2 to the seat cushion S1 and a moving mechanism SR that enables the seat cushion S1 to move with respect to a vehicle floor. In the present embodiment, the moving mechanism SR has left and right lower rails R1 which are fixed to the vehicle floor, and left and right upper rails R2 which are slidably engaging the lower rails R1 and movable back and forth thereon. The seat cushion S1 has a seat cushion frame F1 (see FIG. 11) fixed to the left and right upper rails R2, which will be described later. As a result, the seat cushion S1 (seat body S0) is slidably movable back and forth with respect to the vehicle floor.

As shown in FIGS. 10 and 11, the seat body S0 includes a seat frame F, a seat pad P which covers the seat frame F, and a skin cover SK which covers the seat frame F and the seat pad P.

The seat frame F includes a seat cushion frame F1 forming a frame of a seat cushion S1, and a seatback frame F2 forming a frame of a seatback S2.

The seat pad P is made of foamed plastic such as urethane foam and includes a seat cushion pad P1 which covers the seat cushion frame F1 and a seatback pad P2 which covers the seatback frame F2. The seat cushion pad P1 has a first central portion PC1, and left and right first side portions PS1, which are provided on the left and right sides of the first central portion PC1 and protrude above the first central portion PC1. The seatback pad P2 has a second central portion PC2, and left and right second side portions PS2, which are provided on the left and right sides of the second central portion PC2 and protrude frontward from the second central portion PC2.

The skin cover SK is made of, for example, a fabric, and comprises a seat cushion skin cover SK1 which covers the seat cushion frame F1 and the seat cushion pad P1, and a seatback skin cover SK2 which covers the seatback frame F2 and the seatback pad P2.

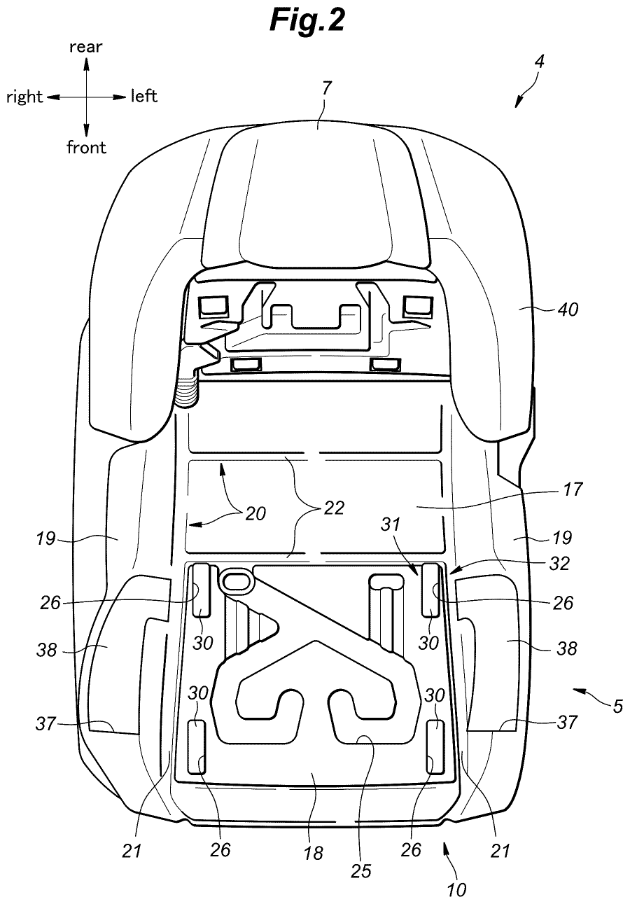

As shown in FIG. 2, the seat cushion S1 has a seat cushion frame F1, a seat cushion pressure receiving member 530 which serves as a pressure receiving member and a support member, and left and right inner covers 540. The seat cushion S1 is formed by the seat cushion frame F1 and the seat cushion pressure receiving member 530 which are covered with the seat cushion pad P1 and the seat cushion skin cover SK1. The seat cushion pad P1 covers the seat cushion frame F1 and the seat cushion pressure receiving member 530, which form the seat frame F.

The seat cushion frame F1 has seat cushion side frames 511 as left and right side frames, a front frame 512, a rear frame 513, and a pan frame 514 as a connecting frame.

The seat cushion side frames 511 are made of seat metal and formed long in the front-rear direction. The left and right seat cushion side frames 511 are laterally spaced apart from each other.

The front frame 512 is made of metal pipe and connects the left and right seat cushion side frames 511 at their front ends.

The rear frame 513 is made of metal pipe and connects the left and right seat cushion side frames 511 at their rear ends.

The pan frame 514 is made of seat metal and connects the left and right seat cushion side frames 511 at their one ends in the longitudinal direction. Specifically, the pan frame 514 connects the left and right seat cushion side frames 511 at their front ends.

In the following description, the longitudinal direction of the seat cushion side frames 511 is also referred to simply as the “longitudinal direction.”

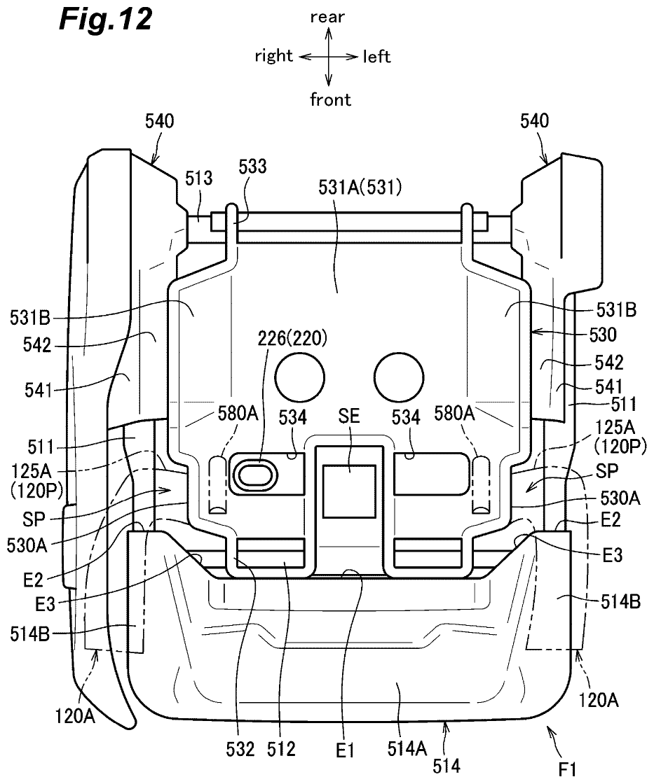

As shown in FIG. 12, the pan frame 514 has a pan frame center portion 514A and left and right pan frame side portions 514B. The pan frame center portion 514A is positioned frontward of the front frame 512. The rear end E2 of the pan frame side portions 514B is positioned rearward of the rear end E1 of the pan frame center portion 514A. The left and right pan frame side portions 514B have respective rear ends E2 and sloping ends E3 that extend rearward to the left and right outer side at an angle, from the left and right ends of the rear end E1 of the pan frame center portion 514A to the respective rear ends E2. Each of the sloping ends E3 extends diagonally to intersect the front frame 512 as viewed from above the seat cushion frame F1, and the rear end E2 of a corresponding one of the pan frame side portions 514B is located rearward of the front frame 512.

The seat cushion pressure receiving member 530 is a plate-shaped member which supports t a seated person and is provided on the opposite side of the seat pad P from the seated person's side. Specifically, the seat cushion pressure receiving member 530 is provided on the opposite side of the seat cushion pad P1 from the seated person's side. With respect to the seat cushion S1, the “seated person's side” corresponds to the upper side, and the “opposite side from the seated person's side” corresponds to the lower side thereof. In other words, the seat cushion pressure receiving member 530 is located on the lower side of the seat cushion pad P1. The seat cushion pressure receiving member 530 of the present embodiment is provided between the left and right seat cushion side frames 511 and supports the seated person between the left and right seat cushion side frames 511.

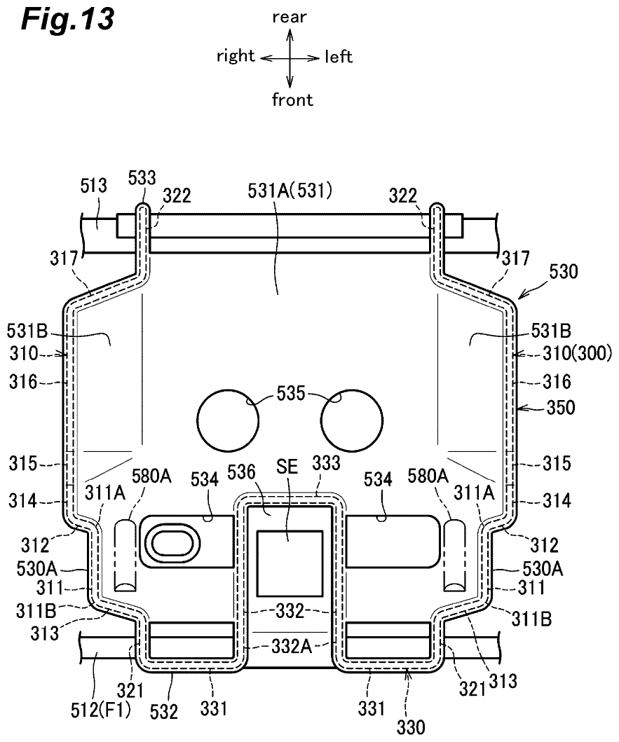

As shown in FIG. 13, the seat cushion pressure receiving member 530 has a body portion 531, front hook portions 532 as first hook portions, and rear hook portions 533 as second hook portions.

The body portion 531 has a first support 531A and left and right second supports 531B located at the left and right rear parts, and is located between the front frame 512 and the rear frame 513. The first supports 531A have two through holes 534 and two through holes 535. The through holes 534 are substantially rectangular through holes formed in the front portion of the body portion 531 extending in the vertical direction, and the two through holes 534 are arranged side by side along the left-right direction. The through holes 535 is through holes formed near the center of the body portion 531 and vertically extending therethrough, and the two through holes 534 are arranged side by side along the left-right direction. The through holes 535 are located near a location corresponding to the most downwardly protruding portion of the sciatic bone of a seated person. The left and right second supports 531B extend diagonally outward and upward from parts of the left and right rear ends of the first supports 531A, respectively (see FIG. 11).

Each of the front hook portions 532 is hook-shaped and configured to be hooked onto the front frame 512 of the seat cushion frame F1 forming the seat frame F. The front hook portions 532 are formed at one longitudinal end of the seat cushion pressure receiving member 530. Specifically, the front hook portions 532 are formed at a front end of the seat cushion pressure receiving member 530.

Each of the rear hook portion 533 is hook-shaped and configured to be hooked onto the rear frame 513 of the seat cushion frame F1. The rear hook portions 533 are formed at the other longitudinal end of the seat cushion pressure receiving member 530. Specifically, the rear hook portions 533 are formed at the rear end of the seat cushion pressure receiving member 530.

The seat cushion pressure receiving member 530 is attached to the seat cushion frame F1 with the front hook portions 532 and the rear hook portions 533, hooked onto the front and rear frames 512, 513, respectively, from the above.

The seat cushion pressure receiving member 530 comprises a metal wire member 300 and a coating member 350 made of non-metal and configured to cover the metal wire member 300. The coating member 350 of the present embodiment is made of plastic and is formed integrally with the metal wire member 300 using a molding process such as an insert molding process and configured to cover the metal wire member 300.

The metal wire member 300 has left and right side portions 310 extending in the front-rear direction through the left and right edges 530A of the seat cushion pressure receiving member 530, and a front portion 330 connecting the front ends of the left and right side portions 310. The left and right side portions 310 extend substantially in the front-rear direction through the left and right edges 530A of the seat cushion pressure receiving member 530. In the present embodiment, the metal wire member 300 comprises a single metal wire material.

Each of the left and right side portions 310 includes a first extension portion 311, a second extension portion 312, a third extension portion 313, a fourth extension portion 314, a fifth extension portion 315 a sixth extension portion 316, a seventh extension portion 317, a front hook portion 321, and a rear hook portion 322.

In the present embodiment, the first extension portions 311 extend longitudinally, i.e., in the front-rear direction. The first extension portions 311 on the left and right extend through the left and right edges 530A of the seat cushion pressure receiving member 530. Each of the edges 530A and a corresponding one of the left and right seat cushion side frames 511 define a placement space SP (see FIG. 12), described below, therebetween.

In the left and right side portions 310, the respective second extension portions 312 extend laterally outward from one longitudinal ends of the corresponding first extension portions 311 to the left and right. Specifically, each second extension portion 312 is a bend from the rear end of a corresponding one of the first extension portions 311 and extends laterally outward. Each of the left and right sides of the metal wire member 300 has a first bend 311A as a bend formed between the first extension portion 311 and the second extension portion 312.

In the left and right side portions 310, the respective third extension portions 313 extend laterally inward from the other longitudinal ends of the first extension portions 311 to the right and left. Specifically, each third extension portion 313 is a bend from the front end of the first extension portion 311 and extends laterally inward. Each of the left and right sides of the metal wire member 300 has a second bend 311B formed between the first extension portion 311 and the third extension portion 313.

In the left and right side portions 310, the fourth extension portions 314 are bent from the rear ends of the second extension portions 312 and extend rearward, and the fifth extension portions 315 are bent from the rear ends of the fourth extension portions 314 and extend diagonally upward. In the left and right side portions 310, the sixth extension portions 316 are bent from the rear ends of the fifth extension portions 315 and extend rearward, and the seventh extension portions 317 are bent from the rear ends of the sixth extension portion 316 and extend laterally inward and rearward and diagonally downward. In each of the left and right side portions 310, the fifth extension portion 315, the sixth extension portion 316 and the seventh extension portion 317 form an edge of a second support 531B, which is part of the edge 530A of the seat cushion pressure receiving member 530.

In each of the left and right side portions 310, the front hook portion 321 is curved to form a substantially arc-shape and extends frontward from the front end of the third extension portion 313. The front hook portion 321 is covered by the coating member 350 and is hooked onto the front frame 512 as part of the front hook portion 532.

In each of the left and right side portions 310, the rear hook portion 322 is curved to form a substantially arc-shape and extends rearward from the rear end of the seventh extension portion 317. The rear hook portion 322 is covered by the coating member 350 and is hooked onto the rear frame 513 as part of the rear hook portion 533.

The front portion 330 has left and right eighth extension portions 331, left and right ninth extension portions 332, and a tenth extension portion 333.

The eighth extension portions 331 are bent from the front ends of the front hook portions 321 and extend laterally inward.

The ninth extension portions 332 are bent from the inner ends of the eighth extension portions 331 and extend rearward. The ninth extension portions 332 have respective hook portions 322A curved to form a substantially arc-shape at the front end, and covered by the coating members 350. In each of the side portions 310, the hook portion 322A and the front hook portion 321 form the front hook portion 532 configured to be hooked onto the front frame 512.

The tenth extension portion 333 extends in the left-right direction to connect the rear ends of the left and right ninth extension portions 332.

The seat cushion pressure receiving member 530 has a sensor placement space 536 in the lateral center part. The sensor placement space 536 is a space in which a seating sensor SE for detecting a seated person is placed. The seating sensor SE is located between the seat cushion pressure receiving member 530 and the seat cushion pad P1. The sensor placement space 536 is surrounded by the ninth extension portions 332 and the tenth extension portion 333, which are coated by the coating member 350. The sensor placement space 536 is located between the left and right through holes 534. Each of the left and right through holes 534 is located between the corresponding first extension portion 311 and the ninth extension portion 332.

As shown in FIG. 12, the inner covers 540 are made of plastic and cover the respective inner sides of the left and right seat cushion side frames 511. Specifically, each of the inner covers 540 has an upper cover portion 541 and a side cover portion 542. The upper cover portion 541 is a portion which covers the upper rear side of a corresponding one of the seat cushion side frames 511. Each side cover portion 542 covers the inner side of the rear portion of a corresponding one of the seat cushion side frames 511, and extends downward from the laterally inner end of the upper cover portion 541 (see FIG. 11). Each side cover portion 542 is located between the corresponding seat cushion side frame 511 and the seat cushion pressure receiving member 530.

As shown in FIG. 11, the seatback S2 has the seatback frame F2 and a seatback pressure receiving member 550. The seatback S2 includes the seatback frame F2 and the seatback pressure receiving member 550, which are covered by the seatback pad P2 and the seatback skin cover SK2. The seatback pad P2 covers the seatback frame F2 and the seatback pressure receiving member 550.

The seatback frame F2 has left and right lower side frames 522, a pipe frame 523, a lower frame 524, and a cross frame 525 as a support member.

The pipe frame 523 is made of metal pipe and has left and right upper side frames 523A and an upper frame 523B extending in the left-right direction to connect the upper ends of the upper side frames 523A. The upper side frames 523A are connected to the lower side frames 522 made of seat metal. The upper side frames 523A and the lower side frame 522 form the seatback side frames 521, which are left and right parts of the seatback frame F2. A pair of holders 527 for holding headrest guides 526 are fixed to the upper frame 523B. A side airbag device SA is secured to the right seatback side frame 521.

The lower frame 524 is made of seat metal and connects the lower parts of the left and right seatback side frames 521.

The cross frame 525 is made of seat metal and is positioned below the upper frame 523B to connect the upper parts of the left and right seatback side frames 521. The cross frame 525 is provided on the opposite side of the seat pad P from the seated person's side and supports the seated person. Specifically, the cross frame 525 is provided on the opposite side of the seatback pad P2 from the seated person's side. With respect to the seatback S2, “seated person's side” corresponds to the front side, and “opposite side from the seated person's side” corresponds to the rear side. In other words, the cross frame 525 is positioned on the rear side of the seatback pad P2.

The seatback pressure receiving member 550 is a plate-shaped member configured to support a seated person and is located at the rear side of the seatback pad P2. The seatback pressure receiving member 550 is provided between the left and right seatback side frames 521, more specifically, between the left and right lower side frames 522, and supports a seating person between the left and right seatback side frames 521. The seatback pressure receiving member 550 has a center support 551 and left and right side supports 552. The side supports 552 extend diagonally outward and frontward from parts of the left and right ends of the center support 551, respectively. The seatback pressure receiving member 550 is connected to the seatback frame F2 by connecting wires 559. For example, the connecting wires 559 are fixed to the lower frame 524 at their lower ends and fixed to the cross frame 525 at their upper ends such that the connecting wires are inserted into holes (not shown) defined in the cross frame 525, whereby the connecting wires 559 are connected to the seatback frame F2. The seatback pressure receiving member 550 is fastened to the connecting wire 559 by using zip ties, and to the seatback frame F2 via the connecting wires 559.

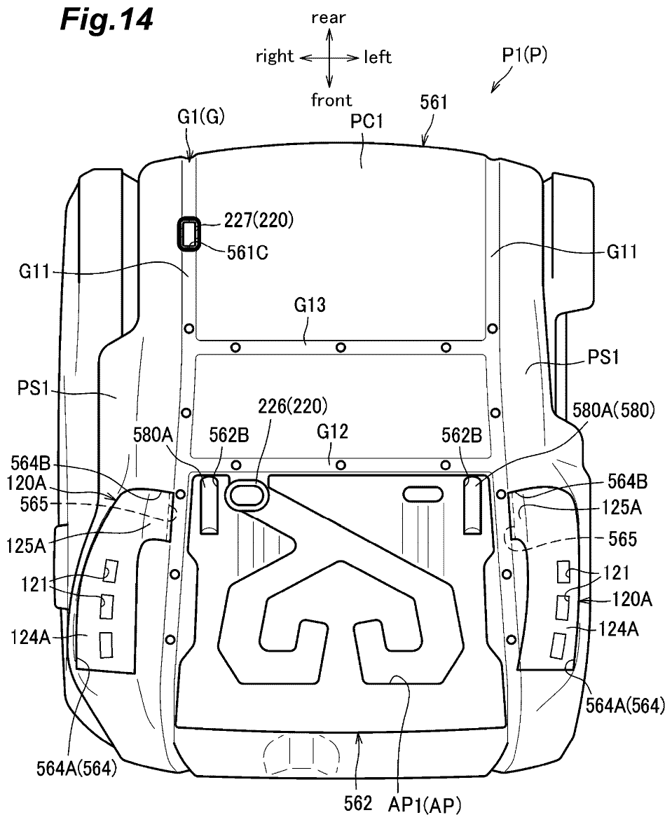

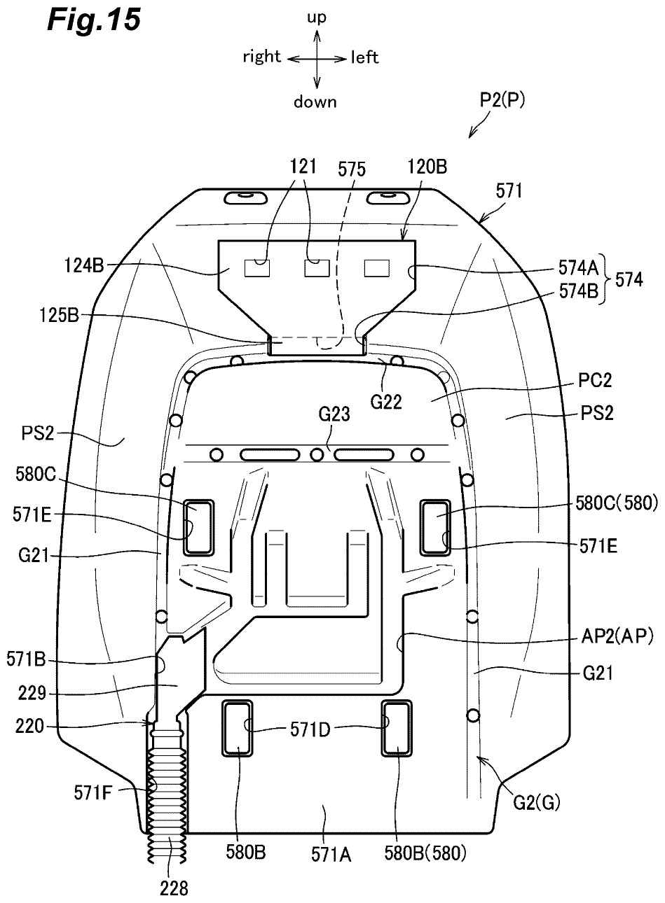

As shown in FIGS. 14 and 15, the seat pad P has a draw-in groove G and a seat air passage AP.

The draw-in groove G is a groove for drawing the skin cover SK therein, and includes a first draw-in groove G1 formed in the seat cushion pad P1 and a second draw-in groove G2 formed in the seatback pad P2.

As shown in FIG. 14, the first draw-in groove G1 is a groove for drawing the seat cushion skin cover SK1 therein, and includes left and right first longitudinal grooves G11, a first lateral groove G12, and a second lateral groove G13 as a first groove.

The left and right first longitudinal grooves G11 are formed to vertically extend between the first central portion PC1 and the corresponding first side portions PS1.

The first lateral groove G12 and the second lateral groove G13 are formed in the first central portion PC1 and extend in the left-right direction. The first lateral groove G12 is formed in the lateral center part of the first central portion PC1, and the second lateral groove G13 is formed rearward of the first lateral groove G12.

As shown in FIG. 15, the second draw-in groove G2 is a groove for drawing the seatback skin cover SK2 therein, and includes left and right second vertical grooves G21, third and fourth lateral grooves G22 and G23 as the first groove.

The left and right second vertical grooves G21 are formed to extend vertically between the second central portion PC2 and the corresponding second side portions PS2.

The third lateral groove G22 is formed in the second central portion PC2 to extend in the left-right direction, which is a predetermined direction. The third lateral groove G22 is formed to connect the upper ends of the left and right second vertical grooves G21.

The fourth lateral groove G23 is formed in the second central portion PC2 extending in the left-right direction. The fourth lateral groove G23 is formed below the third lateral groove G22.

The seat air passage AP is formed on the seat pad P. The seat air passage AP includes a seat cushion air passage AP1 formed on the seat cushion pad P1 (see FIG. 14), and a seatback air passage AP2 formed on the seatback pad P2.

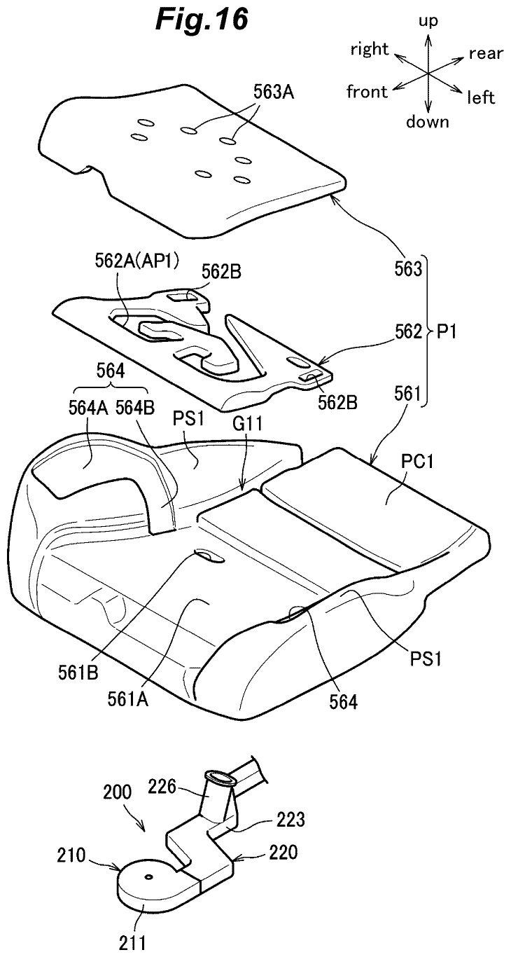

As shown in FIG. 16, the seat cushion pad P1 comprises a first pad body 561, a first lower cover 562, and a first upper cover 563. The first pad body 561 defines a recess 561A at the front of the first central portion PC1 and a connecting hole 561B vertically extending through the first pad body 561 to thereby allow the bottom of the recess 561A to connect to and communicate with the bottom of the seat cushion pad P1. The first lower cover 562 defines a first air passage forming groove 562A vertically extending therethrough. The first upper cover 563 has a plurality of first air passage holes 563A vertically extending therethrough.

In the seat cushion pad P1, the first lower cover 562 is provided on the recess 561A of the first pad body 561, and the first upper cover 563 is provided to cover the first lower cover 562, and the first upper cover 563 is arranged to cover the first lower cover 562 so that the first air passage forming groove 562A of the first lower cover 562 is formed between the bottom surface of the recess 561A of the first pad body 561 and the first upper cover 563, whereby the seat cushion air passage AP1 is formed mainly by the first air passage forming groove 562A. The connecting hole 561B allows the lower side of the seat cushion pad P1 to connect to and communicate with the seat cushion air passage AP1. The first air passage holes 563A are formed at positions corresponding to the first air passage forming groove 562A, as viewed from the above, and allow the upper side of the seat cushion pad P1 to connect to and communicate with the seat cushion air passage AP1.

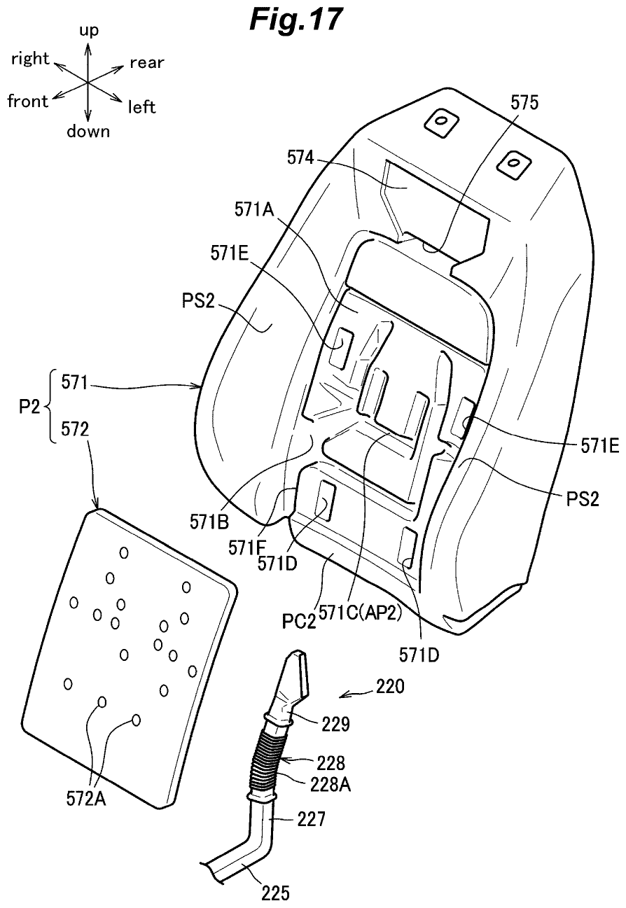

As shown in FIG. 17, the seatback pad P2 comprises a second pad body 571 and a second cover 572. In the lower part of the second central portion PC2, the second pad body 571 defines a recess 571A, a bottomed duct engaging part 571B, and a second air passage forming groove 571C formed at the bottom of the recess 571A. The second cover 572 defines a plurality of second air passage holes 572A extending therethrough in the front-rear direction.

In the seatback pad P2, the second cover 572 is placed on the recess 571A of the second pad body 571 to form the seatback air passage AP2 between the second pad body 571 and the second cover 572, the seatback air passage AP2 being formed mainly by the second air passage forming groove 571C. The second air passage holes 572A are formed at positions corresponding to the second air passage forming groove 571C, as viewed from the front, and allow the front side of the seatback pad P2 to connect to and communicate with the seatback air passage AP2.

The skin cover SK for covering the seat pad P may have a plurality of through holes for allowing for passage of air at the points corresponding to the air passage holes 563A, 572A. Specifically, the seat cushion skin cover SK1 for covering the seat cushion pad P1 may have a plurality of through holes at the locations facing the first air passage holes 563A, and the seatback skin cover SK2 for covering the seatback pad P2 may have a plurality of through holes at locations facing the second air passage holes 572A.

As shown in FIGS. 14 and 15, the vehicle seat S is further provided with vibration generating devices 580. The vibration generating devices 580 are used, for example, to inform a seated person of certain information or to simulate a heavy bass sound by generating vibrations. In the present embodiment, the vibration generating devices 580 include a pair of first vibration generating devices 580A, a pair of second vibration generating devices 580B, and a pair of third vibration generating devices 580C on the left and right, respectively.

As shown in FIG. 14, the first vibration generating devices 580A are provided on the seat cushion S1. Specifically, the first vibration generating devices 580A are embedded in the seat cushion pad P1. The first lower cover 562 forming part of the seat cushion pad P1 has first holes 562B on the left and right sides in the rear part. The first vibration generating devices 580A are provided in the first holes 562B and are arranged between the first pad body 561 and the first upper cover 563. As shown in FIG. 13, the first vibration generating devices 580A are positioned inside the contour of the seat cushion pressure receiving member 530, as viewed from the above. The left and right first vibration generating devices 580A are positioned between the through holes 534 and the first extension portions 311 of the seat cushion pressure receiving member 530, as viewed from the above.

As shown in FIG. 15, the pairs of vibration generating devices 580B, 580C are provided in the seatback S2. Specifically, the vibration generating devices 580B, 580C are embedded in the seatback pad P2. The second pad body 571 forming part of the seatback pad P2 has a pair of second holes 571D and a pair of third holes 571E in the lower part of the recess 571A. The second holes 571D are formed side by side in the lower part of the second pad body 571 and the third holes 571E are formed side by side in a vertical center part of the second pad body 571. The second vibration generating devices 580B are provided in the second holes 571D, and the third vibration generating devices 580C are provided in the third holes 571E and provided between the second pad body 571 and the second cover 572.

As shown in FIG. 10, the air conditioning device 200 is capable of blowing air out from a surface of the seated person's side of the seat body S0. Specifically, the air conditioning device 200 can blow air out from the upper surface of the lateral center part of the seat cushion S1 through the first air passage holes 563A, and also from the front surface of the lateral center part of the seatback S2 through the second air passage holes 572A. As shown in FIG. 16, the air conditioning device 200 has a second air blowing unit 210 and a duct 220.

The second air blowing unit 210 is, for example, a sirocco fan having an impeller (not shown), a motor for rotating the impeller, and a casing 211 for housing the impeller and the motor. The second air blowing unit 210 forms an air flow in the duct 220 and in the seat air passages AP (AP1, AP2) by rotating the impeller. Specifically, the second air blowing unit 210 forms an air flow from the second air blowing unit 210 through the duct 220 and the seat air passages AP (AP1, AP2) to the air passage holes 563A, 572A.

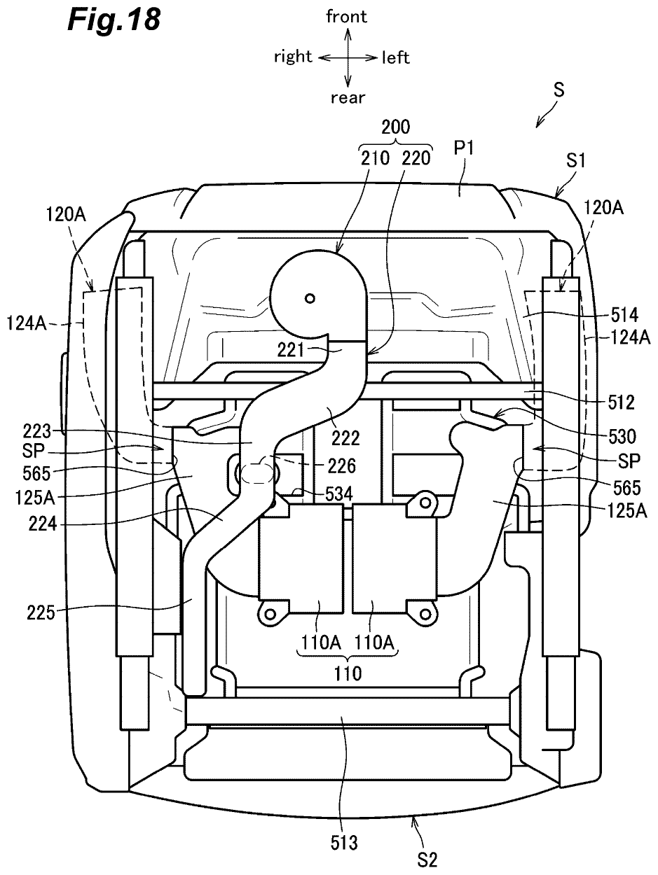

As shown in FIG. 18, the second air blowing unit 210 is provided below and secured to the pan frame 514. The second air blowing unit 210 is secured to the pan frame by any suitable means. For example, the second air blowing unit 210 may be secured to the pan frame 514 directly or via a bracket by screws or other means. In some cases, the second air blowing unit 210 may be fixed to the pan frame 514 by engaging fixing claws on the second air blowing unit 210 with the pan frame 514. In other cases, the second air blowing unit 210 may be fixed to the pan frame 514 by using zip ties, adhesive or other means.

The duct 220 connects the second air blowing unit 210 to the seat air passages AP (AP1, AP2). The duct 220 includes a first connecting pipe member 221, a first pipe member 222, a second pipe member 223, a third pipe member 224, a fourth pipe member 225, and a second connecting pipe member 226. The first connecting pipe member 221 is connected to the second air blowing unit 210. The first pipe member 222 extends diagonally outward and rearward from the rear end of the first connecting pipe member 221, and the second pipe member 223 extends rearward from the rear end of the first pipe member 222. The third pipe member 224 extends diagonally outward and rearward from the rear end of the second pipe member 223, and the fourth pipe member 225 extends rearward from the rear end of the third pipe member 224.

As shown in FIG. 16, the second connecting pipe member 226 is connected to the seat cushion air passage AP1 and extends upward from the second pipe member 223. The second connecting pipe member 226 is connected to the seat cushion air passage AP1 through the right through hole 534 formed in the seat cushion pressure receiving member 530 (see FIG. 18), with the upper end engaging the connecting hole 561B of the seat cushion pad P1.

As shown in FIG. 17, the duct 220 further includes a fifth pipe member 227, a sixth pipe member 228, and a third connecting pipe member 229. The fifth pipe member 227 extends upward from the rear end of the fourth pipe member 225. The sixth pipe member 228 is attached to the upper end of the fifth pipe member 227. The sixth pipe member 228 has a flexible portion 228A. In the present embodiment, the flexible portion 228A has a bellows shape. The sixth pipe member 228 may be integrally molded with at least one of the fifth pipe member 227 and the third connecting pipe member 229.

The third connecting pipe member 229 is connected to the seatback air passage AP2 and is attached to the upper end of the sixth pipe member 228. As shown in FIGS. 14 and 15, the duct 220 is connected to seatback air passage AP2 through a through hole 561C formed in the rear of the seat cushion pad P1 and a groove 571F formed in the lower end part of the seatback pad P2, with the third connecting pipe member 229 engaging the duct engaging part 571B of the seatback pad P2.

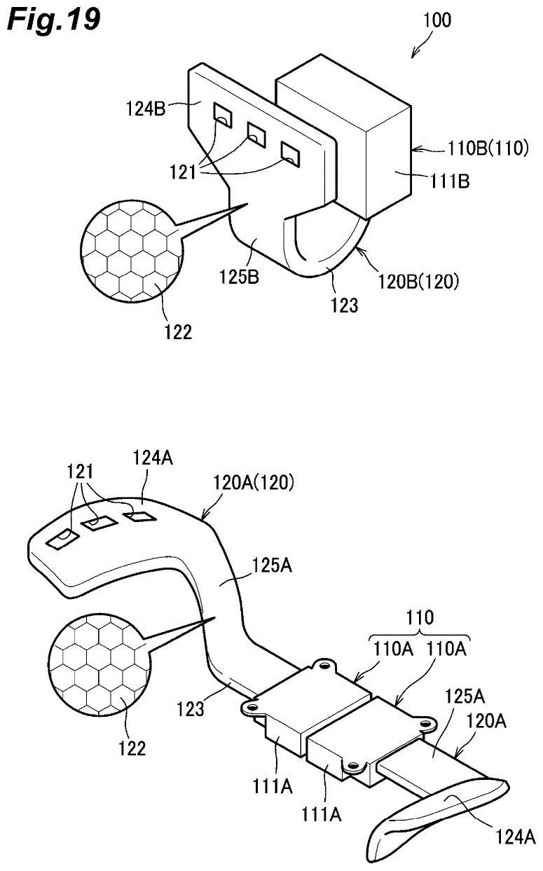

As shown in FIG. 10, the temperature control device 100 enables temperature-controlled air to be blown out from the surface of the seated person's side of the seat body S0. Specifically, the temperature control device 100 is capable of blowing temperature-controlled air from the upper surfaces of the right and left sides of the seat cushion S1 through the blowout ports 121, and also from the front surface of the lateral center parts of the seatback S2 through the blowout ports 121. The skin covers SK (SK1, SK2) may be configured with a plurality of through holes for passage of air at the points corresponding to the blowout ports 121. As shown in FIG. 19, the temperature control device 100 is equipped with the first air blowing units 110 and the air passage bags 120 as air passage forming members.

A first air blowing unit 110 is a device capable of blowing temperature-controlled air. The first air blowing units 110 include two seat cushion air blowing units 110A and a seatback air blowing unit 110B. Each air blowing unit 110A, 110B has, as an example, a blower (not shown), a heat exchanger connected to the blower, and casings 111A, 111B in which the blower and heat exchanger are housed. The heat exchanger may be a device which has the function of either of heating air or cooling air, or both heating and cooling air. The heat exchanger may be formed by using, for example, a PTC heater or a Peltier element.

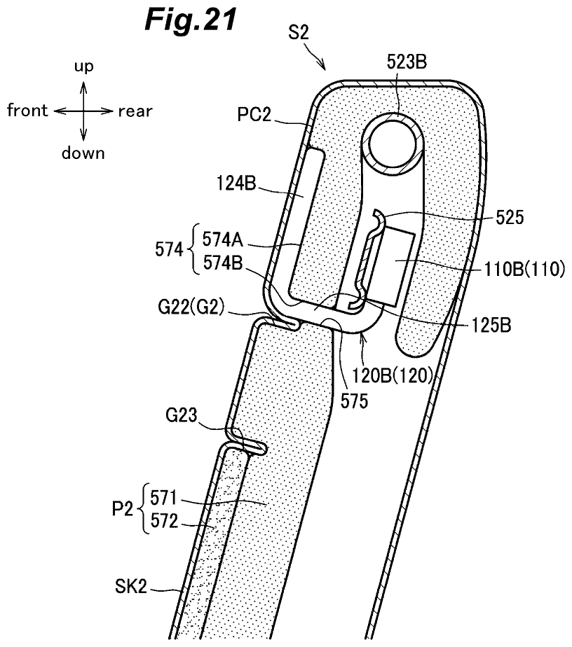

As shown in FIG. 18, the seat cushion air blowing unit 110A is provided below and secured to the seat cushion pressure receiving member 530. The two seat cushion air blowing units 110A are arranged side by side along the left-right direction. As shown in FIG. 21, the seatback air blowing unit 110B is provided behind and secured to the cross frame 525. The air blowing units 110A and 110B are secured to the seat cushion pressure receiving member 530 or the cross frame 525 by any suitable means. For example, the air blowing units 110A, 110B may be secured to the seat cushion pressure receiving member 530 or the cross frame 525 directly via brackets by screws or other means. In some cases, the air blowing units 110A, 110B may also be secured to the seat cushion pressure receiving member 530 or the cross frame 525 by engaging the fixing claws provided on the air blowing units 110A, 110B to the seat cushion pressure receiving member 530 or the cross frame 525. In other cases, the air blowing units 110A, 110B may be fixed to the seat cushion pressure receiving member 530 or the cross frame 525 by using zip ties, adhesive or other means.

The air passage bags 120 direct air from the first air blowing units 110 to the seated person's side of the seat body S0. As shown in FIG. 19, each of the air passage bags 120 has blowout ports 121 for blowing air out from a corresponding one of the air blowing units 110. The air passage bags 120 comprise two seat cushion air passage bags 120A and a seatback air passage bag 120B.

Each of the air passage bags 120A, 120B has a breathable filler 122 and a bag 123 that covers the filler 122. The filler 122 can be formed of, for example, a structure made of three-dimensionally woven or intertwined fibers such as 3D mesh, or a sponge having interconnected cells. Each bag 123 is made of, for example, plastic, and connected to an air blowing unit 110 (110A, 110B) at one end, and has a plurality of blowout ports 121 at the other end. In the seat cushion air passage bags 120A, the respective bags 123 are connected to the seat cushion air blowing units 110A below the seat cushion pressure receiving member 530. In the seatback air passage bag 120B, one end of the bag 123 is connected to the seatback air blowing unit 110B behind the cross frame 525.

Each of the seat cushion air passage bags 120A has a plurality of blowout ports 121, and integrally comprises a blowout portion 124A extending in the front-rear direction, and a pipe member 125A extending out from the rear end of the blowout portion 124A and connected to the seat cushion air blowing unit 110A. The seatback air passage bag 120B has a plurality of blowout ports 121, and integrally comprises a blowout portion 124B having a trapezoidal shape as viewed from the front, and a pipe member 125A extending out from the lower end of the blowout portion 124B at the lateral center part and connected to the seatback air blowing unit 110B.

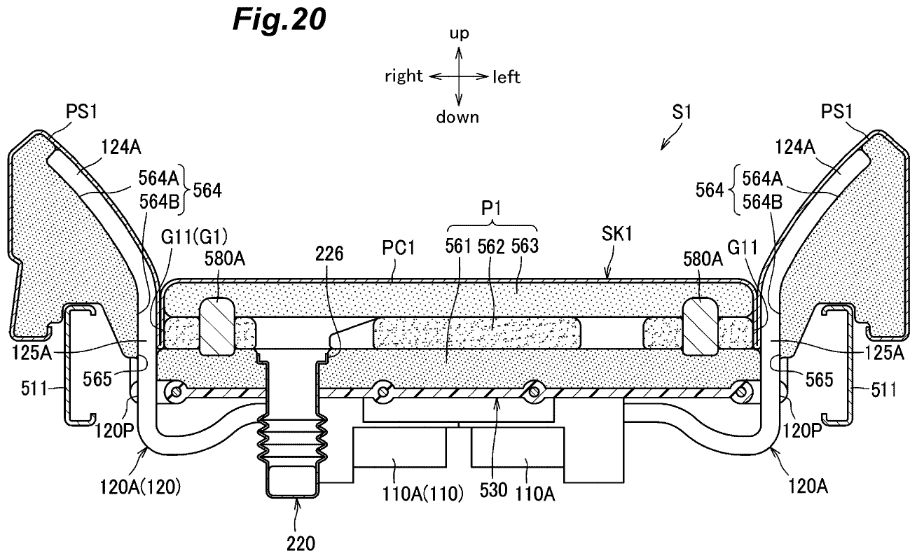

As shown in FIG. 20, the seat cushion pad P1 has the left and right first side portions PS1 having respective first recesses 564 and respective first pad holes 565.

Each of the first side portions PS1 has the first recess 564, in which a seat cushion air passage bag 120A is provided, and which is formed at lateral position outer than a corresponding one of the left and right first longitudinal grooves G11 of the first draw-in groove G1. As shown in FIG. 16, each first recess 564 has a first section 564A, into which the blowout portion 124A of the seat cushion air passage bag 120A is fitted, and a second section 564B, into which the upper portion of the seat cushion pad P1 of the pipe member 125A is fitted. The first section 564A extends substantially in the front-rear direction, and the second section 564B extends downward from the rear end of the first section 564A. The lower end of the second section 564B is recessed laterally outward relative to the first longitudinal groove G11.

As shown in FIG. 14, in each of the left and right first side portions PS1, the seat cushion air passage bag 120A passes through the first pad hole 565 vertically extending through the first side portions PS1. Each first pad hole 565 is formed at a lateral position on the same side relative to the first longitudinal groove G11 as the blowout ports 121 of a corresponding seat cushion air passage bag 120A is provided. Specifically, both the first pad hole 565 and the first recess 564 are located at laterally outer positions than the bottom of the first longitudinal groove G11. The first pad hole 565 extends through the seat cushion pad P1 from the lower end of the second section 564B of the first recess 564. The first pad hole 565 is formed at a longitudinal position which overlaps with the first vibration generating device 580A in the front-rear direction, as viewed from the above. In other words, each first pad hole 565 and a corresponding first vibration generating device 580A are arranged side by side along the left-right direction, as viewed from the above.

In each of the left and right first side portions PS1, the pipe member 125A of a seat cushion air passage bag 120A extends through a corresponding first pad hole 565 formed in the seat cushion pad P1. As shown in FIG. 12, the pipe member 125A extending through the first pad hole 565 passes through a corresponding placement space SP from the upper side to the lower side of the seat cushion pressure receiving member 530. The pipe member 125A extending through the first pad hole 565 also passes between the pan frame 514 and the inner cover 540. As shown in FIG. 18, an end of the pipe member 125A extending through the first pad hole 565 and the placement space SP is connected to a corresponding one of the seat cushion air blowing units 110A, below the seat cushion pressure receiving member 530.

As shown in FIG. 12, each of the left and right placement spaces SP is a space surrounded by a corresponding one of the seat cushion side frames 511, the pan frame 514, and the seat cushion pressure receiving member 530. Specifically, each placement space SP is surrounded by a corresponding seat cushion side frame 511, the sloping end E3 and the rear end E2 of a pan frame side portion 514B of the pan frame 514, and an edge 530A of the seat cushion pressure receiving member 530.

In the present embodiment, each placement space SP is surrounded by a corresponding seat cushion side frame 511, the pan frame 514, the seat cushion pressure receiving member 530, and the inner cover 540. More specifically, the left placement space SP is surrounded by the left seat cushion side frame 511, the pan frame 514, the left edge 530A of the seat cushion pressure receiving member 530, and the left inner cover 540. The right placement space SP is surrounded by the right seat cushion side frame 511, the pan frame 514, the right edge 530A of the seat cushion pressure receiving member 530, and the right inner cover 540.

Each of the seat cushion air passage bags 120A has a pass-through portion 120P. The pass-through portion 120P of a seat cushion air passage bag 120A passes through a corresponding placement space SP. The pass-through portion 120P is located within a longitudinal range which overlaps with a longitudinal position at which the duct 220 is connected to the seat air passage AP. Specifically, the pass-through portion 120P is located within a longitudinal range which overlaps with a longitudinal position of the second connecting pipe member 226 of the duct 220. In other words, the pass-through portion 120P and the second connecting pipe member 226 are arranged side by side along the left-right direction.

The pass-through portion 120P is located within a longitudinal range which overlaps with a longitudinal position of the first vibration generating device 580A. Specifically, the pass-through portion 120P is located within a longitudinal range which overlaps with a longitudinal position of the first vibration generating device 580A. In other words, the pass-through portion 120P and the first vibration generating device 580A are arranged side by side along the left-right direction, as viewed from the above.

The pass-through portion 120P is located between one end and the other end of the seat cushion pressure receiving member 530 in the longitudinal direction. Specifically, the pass-through portion 120P is located between the front end and the rear end of the seat cushion pressure receiving member 530. Moreover, the pass-through portion 120P is positioned rearward of the front end of the seat cushion pressure receiving member 530 and frontward of the rear end thereof.

The pass-through portion 120P is located between the front hook portion 532 and the rear hook portion 533 in the longitudinal direction. Specifically, the pass-through portion 120P is located between the front hook portion 532 and the rear hook portion 533 in the front-rear direction. Moreover, the pass-through portion 120P is positioned rearward of the front hook portion 532 and frontward of the rear hook portion 533.

As shown in FIG. 14, part of each of the seat cushion air passage bags 120A above a first pad hole 565 fits into a corresponding first recess 564 and is located within the first recess 564. Each of the left and right seat cushion air passage bags 120A forms part of the inner surface of a corresponding first longitudinal groove G11 of the first draw-in groove G1. Specifically, the pipe member 125A of a seat cushion air passage bag 120A fits into the second section 564B of a first recess 564, and the laterally inner surface of the pipe member 125A forms part of the inner surface of a first longitudinal groove G11. As shown in FIG. 20, the upper surface of each seat cushion air passage bag 120A in a first recess 564 is flush with the upper surface of a corresponding first side portion PS1 around the first recess 564.

As shown in FIG. 15, the second central portion PC2 of the seatback pad P2 has a second recess 574 and a first pad hole 575.

The second recess 574 is formed above the third lateral groove G22 of the second draw-in groove G2, in which the seatback air passage bag 120B is located. The second recess 574 has a third section 574A, into which the blowout portion 124B of the seatback air passage bag 120B is fitted, and a fourth section 574B, into which a part of the pipe member 125B frontward of the seatback pad P2 is fitted. The third section 574A has a trapezoidal shape as viewed from the front. The fourth section 574B extends downward from the lower end of the third section 574A at the center portion along the left-right direction, bends, and extends rearward along the upper side of the third lateral groove G22. The fourth section 574B is recessed upward relative to the upper side of the third lateral groove G22.

The first pad hole 575 is a hole through which the seatback air passage bag 120B passes and is formed to extend therethrough in the front-rear direction. The first pad hole 575 is formed on the same side as the side on which the blowout ports 121 of the seatback air passage bag 120B are located with respect to the third lateral groove G22. In particular, the first pad hole 575 is formed at a lateral position on the same side relative to the third lateral groove G22 as the second recess 574. Specifically, the first pad hole 575 and the second recess 574 are formed above the bottom of the third lateral groove G22. The first pad hole 575 extends through the seatback pad P2 from the rear end of the fourth section 574B of the second recess 574.

As shown in FIG. 21, the pipe member 125B of the seatback air passage bag 120B passes through the first pad hole 575 extending through the seatback pad P2 in the front-rear direction. The end of pipe member 125B extending through the first pad hole 575 is connected to the seatback air blowing unit 110B on the rear side of the cross frame 525.

A part of the seatback air passage bag 120B located frontward of the first pad hole 575 fits into and is positioned within the second recess 574. The seatback air passage bag 120B forms part of the inner surface of the third lateral groove G22 of the second draw-in groove G2. Specifically, the pipe member 125B of the seatback air passage bag 120B fits into the fourth section 574B of the second recess 574, and the lower surface of the pipe member 125B forms part of the inner surface of the third lateral groove G22. The front side of the seatback air passage bag 120B located in the second recess 574 is flush with the front surface of the second central portion PC2 around the second recess 574.

In the vehicle seat S described above, each of the left and right seat cushion air passage bags 120A extends through a corresponding placement space SP, which is surrounded by a corresponding seat cushion side frame 511, the pan frame 514, and the seat cushion pressure receiving member 530. This configuration allows a seat cushion air passage bag 120A, which is an air passageway, to be compactly arranged compared to, for example, a case where the air passageway passes behind the first side portion of the seat cushion pad. In addition, the pass-through portion 120P of a seat cushion air passage bag 120A is surrounded by a seat cushion side frame 511, the pan frame 514, and the seat cushion pressure receiving member 530. This configuration allows the seat cushion side frame 511, the pan frame 514, and the seat cushion pressure receiving member 530 to prevent the seat cushion air passage bag 120A from moving in the left-right direction, and protect the seat cushion air passage bag 120A.

In addition, the pass-through portion 120P of each of the left and right seat cushion air passage bags 120A is located within a longitudinal range which overlaps a longitudinal position of the second connecting pipe member 226 of the duct 220, which allows the seat cushion air passage bag 120A and the duct 220 to be compactly provided in the front-rear direction. Moreover, the second connecting pipe member 226 extends through the through hole 535 of the seat cushion pressure receiving member 530 and is connected to the seat cushion air passage AP1, which allows parts of the seat cushion pressure receiving member 530, i.e., the left and right edges 530A of the seat cushion pressure receiving member 530 to be placed between the left and right seat cushion air passage bags 120A and the duct 220, respectively. In this configuration, the seat cushion pressure receiving member 530 prevents the seat cushion air passage bags 120A from interfering with the duct 220.

Furthermore, the left and right seat cushion air passage bags 120A extend between the pan frame 514 and the inner cover 540, which allows the seat cushion air passage bags 120A and the inner cover 540 to be arranged side by side along the front-rear direction. This configuration allows the seat cushion air passage bags 120A and the inner cover 540 to be compactly arranged in the left-right direction, and also allows the inner cover 540 to prevent the seat cushion air passage bags 120A from moving rearward and protect the seat cushion air passage bags 120A.

In addition, the left and right edges 530A of the seat cushion pressure receiving member 530 are stiffened by the first extension portions 311 of the metal wire member 300 extending therethrough, which enables the formation of placement spaces SP, through which the seat cushion air passage bags 120A pass, respectively.

Furthermore, the left and right bends 311A, 311B further increase the stiffness of areas near the first extension portions 311 of the metal wire member 300, thereby further stiffening the edges 530A of the seat cushion pressure receiving member 530, which form the placement spaces SP, through which the left and right seat cushion air passage bags 120A pass, respectively.

Moreover, the pass-through portions 120P of the seat cushion air passage bags 120A are located within a longitudinal range that overlaps with a longitudinal position of the first vibration generating devices 580A, which allows the seat cushion air passage bags 120A and the first vibration generating devices 580A to be compactly arranged in the front-rear direction. Since the left and right first vibration generating devices 580A are arranged inner side of the contour of the seat cushion pressure receiving member 530, as viewed from the above, the edges 530A of the seat cushion pressure receiving member 530 are positioned between the seat cushion air passage bags 120A and the first vibration generating devices 580A, respectively. This configuration allows the seat cushion pressure receiving member 530 to prevent the seat cushion air passage bags 120A from interfering with the first vibration generating devices 580A.

The pass-through portions 120P of the seat cushion air passage bags are located between the front and rear ends of the seat cushion pressure receiving member 530 in the front-rear direction, which allows the seat cushion air passage bags 120A and the seat cushion pressure receiving member 530 to be compactly arranged in the front-rear direction.

The pass-through portions 120P are positioned between the front hook portions 532 and the rear hook portions 533 in the front-rear direction, which prevents the seat cushion air passage bags 120A from interfering with members, onto which the seat cushion pressure receiving member 530 of the seat cushion frame F1 is hooked. Specifically, this configuration prevents the seat cushion air passage bags 120A from interfering with the front frame 512 and the rear frame 513.

In the vehicle seat S described above, the seat cushion air passage bags 120A pass through the first pad holes 565 vertically extending through the seat cushion pad P1, and the seatback air passage bags 120B pass through the first pad holes 575 longitudinally extending through the seatback pad P2, which allows the air passage bags 120, which are air passages, to be compactly arranged. Each of the left and side first pad holes 565 of the seat cushion pad P1 is positioned on the same side of a corresponding first longitudinal groove G11 of the draw-in groove G1, as the blowout ports 121 of a corresponding seat cushion air passage bag 120A, which means that each first longitudinal groove G11 does not cross a portion of a corresponding seat cushion air passage bag 120A which exits from a first pad hole 565 to the upper side of the seat cushion pad P1. This configuration prevents each seat cushion air passage bag 120A from becoming an obstacle when the seat cushion skin cover SK1 is drawn in the first draw-in groove G1. Similarly, the first pad hole 575 of the seatback pad P2 is positioned on the same side of the third lateral groove G22 of the second draw-in groove G2, as the blowout ports 121 of the seatback air passage bag 120B, which means that the third lateral groove G22 does not cross a portion of the seatback air passage bag 120B which exits from the first pad hole 575 of the seatback air passage bag 120B to the front side of the seatback pad P2. This configuration prevents the seatback air passage bag 120B from becoming an obstacle when the seatback skin cover SK2 is drawn in the first draw-in groove G2.

Each of the seat cushion air passage bags 120A forms a part of the inner surface of a corresponding first longitudinal groove G11, which allows the seat cushion air passage bag 120A to be in contact with the first draw-in groove G1. This configuration enables the seat cushion air passage bags 120A to be compactly arranged. Similarly, the seatback air passage bag 120B forms part of the inner surface of the third lateral groove G22, which allows the seatback air passage bag 120B to be in contact with the second draw-in groove G2. This configuration enables the seatback air passage bag 120B to be compactly arranged.

In the seat cushion S1, the left and right first recesses 564, in which the seat cushion air passage bags 120A are placed, are formed in the first side portions PS1 of the seat cushion pad P1 where a pressure is hardly applied from the seated person, which allows the seat cushion pad P1 to be made thinner at positions which are less likely to affect the comfort of seating.

The upper surface of each of the seat cushion air passage bags 120A placed in a first recess 564 is flush with the upper surface of a corresponding first side portion PS1 around the first recess 564, resulting in that the shape of the seat cushion air passage bag 120A is less likely to appear on the surface of the seat cushion S1. This configuration allows the seat cushion air passage bags 120A to be arranged without negatively affecting the design of the vehicle seat S.

Each of the first pad holes 565 is located within a longitudinal range which overlaps with a longitudinal position of a corresponding first vibration generating device 580A, which allows part of a seat cushion air passage bags 120A passing through the first pad hole 565 and the first vibration generating device 580A to be compactly arranged in the front-rear direction, in which the first longitudinal groove G11 extends.

In the seatback S2, the second central portion PC2 has a second recess 574, in which the seatback air passage bag 120B is located, which allows temperature-controlled air to be blown from the laterally center of the seatback S2.

The front surface of the seatback air passage bag 120B placed in the second recess 574 is flush with the front surfaces of the second side portions PS2 around the second recess 574, resulting in that the seatback air passage bag 120B is less likely to appear on the surface of the seatback S2. This configuration allows the seatback air passage bag 120B to be arranged without negatively affecting the design of the vehicle seat S.

The seat cushion air blowing units 110A are positioned below and secured to the seat cushion pressure receiving member 530, which prevents a seated person from having a foreign body sensation due to the placed seat cushion air blowing units 110A. Similarly, the seatback air blowing unit 110B is positioned behind and secured to the rear side of the cross frame 525, which prevents a seated person from having a foreign body sensation due to the seatback air blowing unit 110B.

The specific embodiments of the present invention are described above. However, various modifications may be made to the vehicle seats of the above-described embodiments. Except for what will be discussed below, the description of the same features as the above-described embodiments will not be repeated, and the same reference numerals are retained for corresponding features.

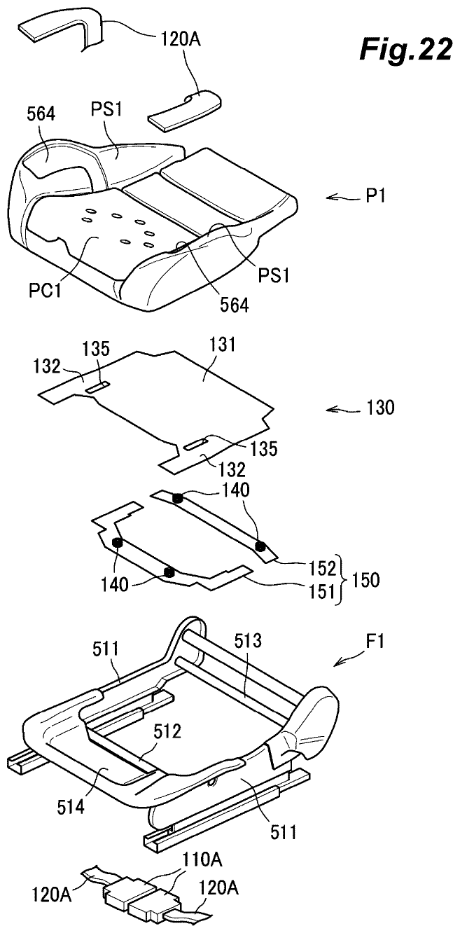

As shown in FIG. 22, a seat cushion S1 of the vehicle seat S according to a first modified embodiment of the present invention comprises a seat cushion pressure receiving member 130 as the pressure receiving member, four compression coil springs 140 as elastic members, and plates 150.

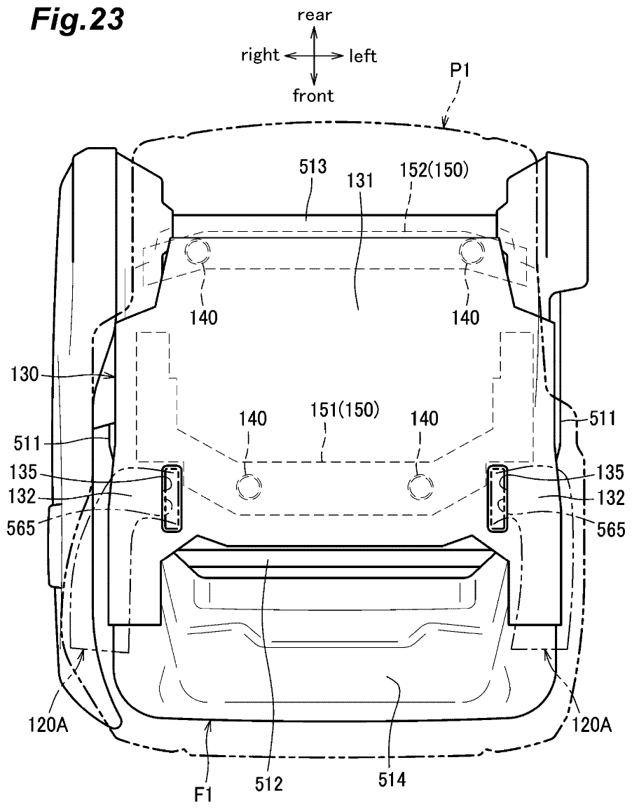

The seat cushion pressure receiving member 130 is a plate-shaped member configured to support a seated person, and is located on the underside of the seat cushion pad P1. The seat cushion pressure receiving member 130 has a body 131 and left and right extension portions 132. The body 131 is positioned between left and right seat cushion side frames 511 in the left-right direction. The extension portions 132 extend outward from the left and right ends of the body 131. Specifically, as shown in FIG. 23, the extension portions 132 extend so as to overlap the corresponding seat cushion side frames 511 as viewed from the above. In other words, each extension portion 132 covers a part of the corresponding seat cushion side frame 511 from the above.

The seat cushion pressure receiving member 130 further has left and right through holes 135 extending therethrough in the vertical direction. The through holes 135 are formed at positions which overlap the first pad holes 565 formed in the seat cushion pad P1, as viewed from the above.

The plates 150 are configured to elastically support the seat cushion pressure receiving member 130 via the compression coil springs 140, and positioned below the seat cushion pressure receiving member 130. The plates 150 extend across the left and right seat cushion side frames 511, and left and right end parts of the plants are secured to the corresponding seat cushion side frames 511. The left and right end parts of the plates 150 may be secured directly to the corresponding seat cushion side frames 511, or may be secured thereto via brackets or other suitable components.

The plates 150 include a first plate 151 and a second plate 152 positioned rearward of the first plate 151. The first plate 151 extends across and is secured to the left and left seat cushion side frames 511 at a longitudinal position near the longitudinal center thereof. The second plate 152 extends across and is secured to the left and left seat cushion side frames 511 at rear parts thereof.

The compression coil springs 140 are provided between the plate 150 and the seat cushion pressure receiving member 130. The lower and upper ends of each of the compression coil springs 140 are in contact with the plate 150 and the seat cushion pressure receiving member 130, respectively.

The first pad holes 565 formed in the seat cushion pad P1 and the through holes 135 formed in the seat cushion pressure receiving member 130 are located at different positions from the plates 150 (151, 152), as viewed from the above. In other words, the first pad holes 565 and the through holes 135 are positioned so as not to overlap with the plates 150 (151, 152), as viewed from the upper side.

The seat cushion air passage bags 120A vertically pass through the seat cushion pad P1, extending through the first pad holes 565 in the seat cushion pad P1 and further through the through holes 135 in the seat cushion pressure receiving member 130.

In the first modified embodiment, the vehicle seat S may be configured such that the seat cushion air passage bags 120A can be placed, even when the plate-shaped seat cushion pressure receiving member 130 for supporting a seated person has the extension portions 132.

Since the first pad holes 565 and the through holes 135 are positioned at different positions from the plate 150 as viewed from the above, the seat cushion air passage bags 120A can be placed, with the seat cushion pressure receiving member 130 being elastically supported.

In the first modified embodiment, the compression coil springs 140 are used as elastic members for illustrative purposes. However, other types of elastic members such as a plate spring may be used as an elastic member. In the first modification, the plates 150 include two members, a first plate 151 and a second plate 152. However, the plates may include one member or three or more members.

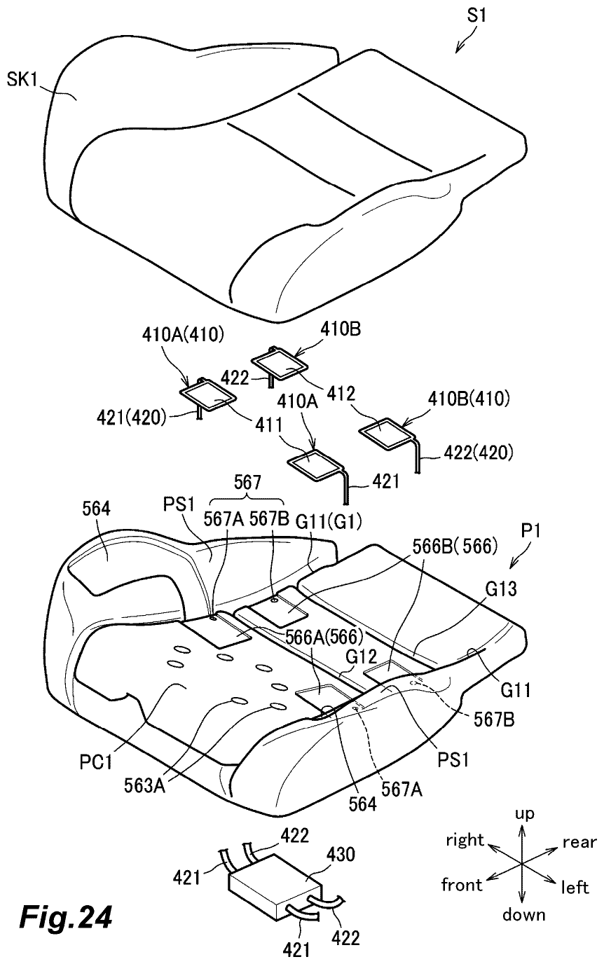

As shown in FIG. 24, a seat cushion S1 of the vehicle seat S according to a second modified embodiment of the present invention comprises bag members 410, hoses 420, and a supply-evacuation device 430.

Each bag member 410 is capable of inflating and deflating to massage a seated person with air and provided between the seat cushion pad P1 and the seat cushion skin cover SK1. More specifically, each bag member 410 is provided between the first central portion PC1 of the seat cushion pad P1 and the seat cushion skin cover SK1.

Each of the bag member 410 is a bag-shaped member formed by overlapped two seat-like members which are bonded at their peripheral edges by e.g., crimping, bonding, or welding. In the present embodiment, the bag members 410 include a front pair of first bag members 410A and a rear pair of second bag members 410B. Each first bag member 410A has a first bag-shaped portion 411 as a bag-shaped portion capable of inflating and deflating, and a second bag member 410B has a second bag-shaped portion 412 capable of inflating and deflating.

The hoses 420 are connected to and communicate with the corresponding bag members 410 and allow fluid to flow into and out of the bag members 410. The hoses 420 include a pair of first hoses 421 and a pair of second hoses 422. Each first hose 421 is connected at one end to the first bag-shaped portion 411 of a corresponding first bag member 410A and at the other end to the supply-evacuation device 430. Each second hose 422 is connected at one end to the second bag-shaped portion 412 of the corresponding second bag member 410B and at the other end to the supply-evacuation device 430.

The supply-evacuation device 430 is configured to supply and evacuate fluid such as air to the bag members 410, and includes a pump, a solenoid valve, and a control device for controlling the pump and solenoid valve (not shown). The supply-evacuation device 430 may be secured to the pan frame 514 in the same manner as, e.g., the second air blowing unit 210 (see FIG. 18), with the supply-evacuation device 430 provided on the underside of the pan frame 514. In some cases, the supply-evacuation device 430 may be secured to the seat cushion pressure receiving member 530 in the same manner as the seat cushion air blowing unit 110A (see FIG. 18), with the supply-evacuation device 430 provided on the underside of the seat cushion pressure receiving member 530.

The seat cushion pad P1 further includes bag accommodation recesses 566 and hose holes 567.

Each bag accommodating recess 566, in which the bag member 410 is provided, is recessed toward the lower side against the upper side of the seat cushion pad P1. The bag accommodating recesses 566 include a pair of first bag accommodating recesses 566A in which the first bag member 410A is provided on the left and right and a pair of second bag accommodating recesses 566B in which the second bag member 410B is provided on the left and right. The first bag accommodating recesses 566A are formed frontward of the first lateral groove G12 of the first draw-in groove G1 and at the left and right ends of the upper side of the first central portion PC1, respectively. The second bag accommodating recesses 566B are provided between the first lateral groove G12 and the second lateral groove G13 of the first draw-in groove G1 and at the left and right ends of the upper side of the first central portion PC1.

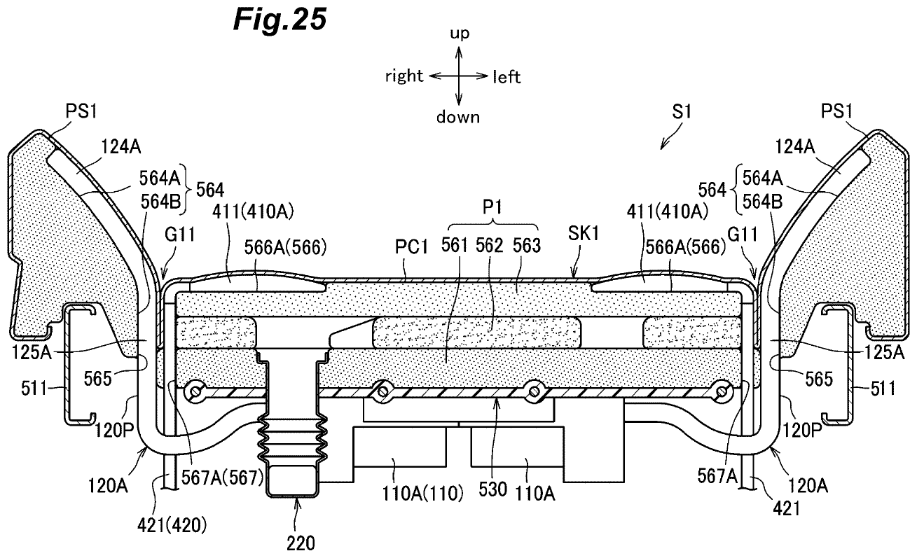

As shown in FIG. 25, the hose holes 567 extend through the seat cushion pad P1. The hose holes 567 are formed at locations on the opposite side of the first longitudinal groove G11 of the first draw-in groove G1 from the side of the first pad holes 565. Specifically, the first pad holes 565 are formed at locations on the left and right outer sides of the first longitudinal groove G11, and the hose holes 567 are formed at locations on the left and right inner sides of the first longitudinal groove G11. More specifically, the first pad holes 565 are formed in the first side portions PS1 and the hose holes 567 are formed in the first central portion PC1. The hose holes 567 include first hose holes 567A and second hose holes 567B as second pad holes (see FIG. 24). Each of the left and right first hose holes 567A is formed at a position on the opposite side of the first longitudinal groove G11 from the first pad hole 565, so that the first hose hole 567A and the first pad hole 565 are located side by side along the left-right direction with the first longitudinal groove G11 therebetween.

The hoses 420 extend through the corresponding hose holes 567 in the seat cushion pad P1. Specifically, the first hoses 421 pass through the first hose holes 567A, vertically extending through the seat cushion pad P1. The second hoses 422 (see FIG. 24) pass through the second hose holes 567B, vertically extending through the seat cushion pad P1.

A first bag-shaped portion 411 of each of the left and right first bag members 410A is positioned on the laterally inner side of the first bag member 410A, further away from the first longitudinal groove G11 than the first hose hole 567A, while the first bag members 410A are provided in the first bag accommodating recesses 566A. Although not shown in the drawings, A second bag-shaped portion 412 of each of the left and right the second bag members 410B is positioned on the laterally inner side further away from the first longitudinal groove G11 than the second hose hole 567B, while the second bag members 410B are provided in the second bag accommodating recesses 566B.

In a vehicle seat S according to the second modified embodiment (FIG. 25), each of the seat cushion air passage bags 120A passes through a first pad hole 565 vertically extending through the seat cushion pad P1, and each of the first hoses 421 passes through a first hose hole 567A, resulting in that each seat cushion air passage bag 120A and a corresponding first hose 421 pass through the seat cushion pad P1, with a corresponding first longitudinal groove G11 located therebetween. This configuration prevents the seat cushion air passage bags 120A from interfering with the first hoses 421.

The first bag-shaped portion 411 of each of the left and right first bag member 410A is positioned laterally inward and further away from a corresponding first longitudinal groove G11 than a first hose hole 567A, with the first longitudinal groove G11 located therebetween. This configuration prevents the seat cushion air passage bags 120A from interfering with the first bag-shaped portions 411 capable of inflating and deflating.

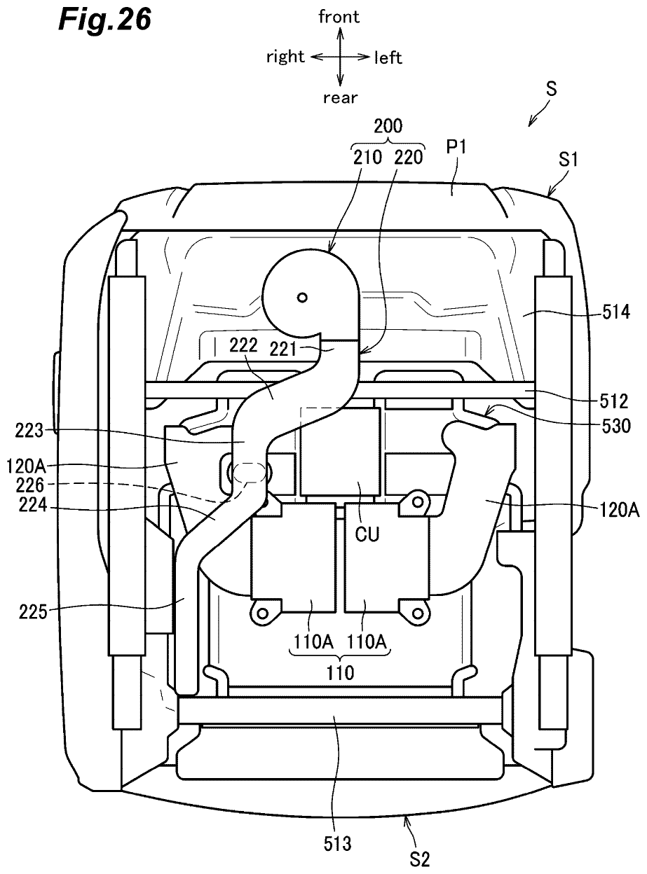

As shown in FIG. 26, a vehicle seat S according to a third modified embodiment of the present invention is equipped with a control unit CU capable of controlling an air conditioning device 200. The control unit CU includes a CPU, ROM, RAM, an input/output circuit and other features (not shown), and is configured to control the second air blowing unit 210 by executing pre-stored programs. More specifically, the control unit CU controls the rotation and stop of an impeller (motor) of the second air blowing unit 210 and the rotation speed of the impeller (motor). The control unit CU is secured to and positioned below the seat cushion pressure receiving member 530.

The control unit CU is positioned side by side with a part of the air conditioning device 200 and the first air blowing unit 110 in the front-rear direction, as viewed from below the vehicle seat S. The front-rear direction is an example of an orthogonal direction, which is orthogonal to the left-right direction. In other words, the control unit CU is arranged side by side with the seat cushion air blowing unit 110A and the second air blowing unit 210 in the front-rear direction as viewed from the below. More specifically, the control unit CU is positioned between the seat cushion air blowing unit 110A and the second air blowing unit 210, viewed from the below.

The control unit CU and the duct 220 are arranged side by side along the left-right direction, as viewed from the below. Specifically, the control unit CU and the second pipe member 223 of the duct 220 are located side by side along the left-right direction, as viewed from the below. A part of the control unit CU is vertically aligned with a part of the duct 220. Specifically, a front end of a right part of the control unit CU is positioned vertically aligned with the first pipe member 222 of the duct 220. In other words, the front end of the right part of the control unit CU is positioned to overlap the first pipe member 222, as viewed from the below. Moreover, the control unit CU is positioned above the second pipe member 223.

In the vehicle seat S of the third modified embodiment, the control unit CU is aligned with the first air blowing unit 110 and the second air blowing unit 210 in the front-back direction, as viewed from the bottom, which allows the control unit CU, the air conditioning device 200, and the seat cushion air blowing unit 110A to be compactly arranged in the left-right direction.

The control unit CU is aligned with and positioned between the seat cushion air blowing unit 110A and the second air blowing unit 210 in the front-rear direction, as viewed from the below, while being aligned with the duct 220 in the left-right direction. This configuration allows the control unit CU, the seat cushion air blowing unit 110A, and the second air blowing unit 210 to be compactly arranged in the left-right direction, and also enables efficient use of the space surrounded by the seat cushion air blowing unit 110A, the second air blowing unit 210, and the duct 220.

In the above-described embodiments, the connecting frame is the pan frame 514 made of seat metal. However, in some cases, the connecting frame may be a frame made of e.g., metal pipe.

In the above-described embodiments, the seat cushion pressure receiving member 530 is configured such that the left and right second supports 531B extend outwardly from parts of the left and right ends of the first supports 531A, respectively. However, in some cases, the second supports may be configured to extend outward from the entire left and right ends of the first supports to the left and right sides. In other cases, the seat cushion pressure receiving member may be a flat plate without the second supports. In the above-described embodiments, the seatback pressure receiving member 550 is configured such that the side supports 552 extend outward from parts of the left and right ends of the center supports 551, respectively. However, in some cases, the side supports may be configured to extend outward from the entire left and right ends of the center support. In other cases, the seatback pressure receiving member may be configured without side supports.

In the above-described embodiments, the seat cushion pressure receiving member 530 serves as both a pressure receiving member and a support member. However, the pressure receiving member and the support member may be separate members. For example, in the vehicle seat S of the first modified embodiment shown in FIG. 22, in which the seat cushion air blowing unit 110A may be provided below and secured to the first plate 151, the first plate 151 is a support member positioned below the seat cushion pad P1 for supporting a seated person, and is a separate pressure receiving member from the seat cushion pressure receiving member 130.

In the above-described embodiments, the seat cushion pressure receiving member 530 comprises the metal wire member 300 and the plastic coating member 350 that covers the metal wire member 300. However, in some cases, the plate-shaped pressure receiving member may be formed only of plastic. In other cases, the plate-shaped pressure receiving member may be formed of an elastic material such as an elastomer.

In the above-described embodiments, the seat body S0 is configured with the inner cover 540. However, in some cases, the seat body may be configured without an inner cover.

In the above-described embodiments, the vehicle seat S is configured with the vibration generating devices 580. However, in some cases, the vehicle seat may be configured without vibration generating devices.

In the above-described embodiments, each of the air passage bags 120, which serves as an air passage forming member, forms part of the inner surface of the draw-in groove G. However, for example, a vehicle seat may be configured such that an air passage forming member does not form part of the inner surface of the draw-in groove. In other words, the first pad hole, through which the air passage forming member passes, may be positioned away from the first groove, as viewed from a seated person's side.

In the above-described embodiments, each air passage bags 120 comprises a bag 123 containing a breathable filler 122 and is used as an air passage forming member. However, in some cases, the air passage forming member may include a blowout unit having blowout ports, and a duct for connecting the blowout unit to the first air blowing unit, and the duct passes through the first pad hole or placement space.

In the above-described embodiments, the seat cushion has the left and right side frames, the connecting frame, and the pressure receiving member, which form the placement space, through which the air passage forming member passes. However, in some cases, the seatback may have left and right side frames, a connecting frame, and a pressure receiving member, which form a placement space, through which the air passage forming member passes. In other words, the air passage forming member extending through the placement space may be provided in the seatback. Moreover, the seatback may be configured in a similar manner to the seat cushion S1 in the above-described embodiments and variants, and the seat cushion may be configured in a similar manner to the seatback S2 in the above-described embodiments.

In the above-described embodiments, the two seat cushion air blowing units 110A are provided side by side along the left-right direction. However, in some cases, only one seat cushion air blowing unit may be provided. In the above embodiments, the first air blowing unit 110 includes the seat cushion air blowing unit 110A and the seatback air blowing unit 110B provided on the seat cushion S1 and the seatback S2, respectively. However, in some cases, a common first air blowing unit may be used to blow temperature-controlled air to both the seat cushion and the seatback.

In the above-described embodiments, the temperature control device 100 enables temperature-controlled air to be blown out from both the seat cushion S1 and the seatback S2. However, in some cases, the temperature control device may enable temperature-controlled air to be blown out only from the seat cushion. The same applies to the air conditioning device.

In the above-described embodiments, the air conditioning device 200 is capable of blowing air out from a seated person's side surface of the seat body S0. However, in some cases, the air conditioning device may be configured to allow air to be drawn in from a seated person's side surface of the seat body. For example, the air conditioning device may be configured to blow air out from the upper side of the seat cushion and draw air in from the front side of the seatback. Conversely, the air conditioning device may be configured to draw air in from the upper side of the seat cushion and blow air out from the front side of the seatback. In other cases, the vehicle seat may be configured without an air conditioning device.

In the above-described embodiments, the moving mechanisms SR is configured to enable the seat cushion S1 to move back and forth with respect to the vehicle floor. However, in some cases, the moving mechanisms may be configured to enable the seat cushion to move left and right relative to the vehicle floor. In some cases, the moving mechanisms may be configured to enable the seat cushion to move up and down with respect to the vehicle floor. In some cases, the moving mechanisms may be configured to enable the seat cushion to rotate with respect to the vehicle floor. In some cases, the moving mechanisms may also be configured to include multiple types of moving mechanisms. For example, the moving mechanisms may comprise a first moving mechanism which enables the seat cushion to move back and forth and a second moving mechanism that enables the seat cushion to move up and down.

In the above-described embodiments, the prevent invention is applied to the vehicle seat S installed in an automobile. However, the present invention may be applied to a seat installed in any other vehicle such as a railroad car, a ship, or an aircraft. The present invention may also be applied to a home use seat or any other indoor seat.

Elements and features of the above-described embodiments may be combined with each other as appropriate to yield an embodiment which is within the scope of the present invention.

### Glossary

1 vehicle seat system
2 vehicle (motor vehicle)
4 seat body
5 seat cushion
6 seatback
first vibration device
control device
pressure receiving member
60 second vibration device
61 occupant detection device
62 rotation angle sensor
63 external information acquisition device
75 object
78 acceleration sensor

1. A vehicle seat system comprising:
a seat body mounted on a vehicle, the seat body having a seat cushion and a seatback;
an external information acquisition device for acquiring external information, which is information external to the vehicle;
one or more first vibration devices provided in the seat cushion;
one or more second vibration devices provided in the seatback; and
a control device configured to control the first and second vibration devices according to the external information,
wherein the control device is configured to cause one of the first and second vibration devices to vibrate, followed by causing the other of the first and second vibration devices to vibrate.

2. The vehicle seat system of claim 1, wherein
the first vibration devices comprise one or more front first vibration devices located in a front part of the seat cushion and one or more rear first vibration devices located in a rear part of the seat cushion, and
the second vibration devices comprise one or more upper second vibration devices located in an upper part of the seatback and one or more lower second vibration devices located in a lower part of the seatback,
wherein the control device causes the first vibration devices and the second vibration devices to vibrate in a first vibration pattern or a second vibration pattern,
wherein, in the first vibration pattern, the control device causes the first vibration devices to vibrate in order from the front first vibration devices to the rear first vibration devices, and then causes the second vibration devices to vibrate in order from the lower second vibration devices to the upper second vibration devices,
whereas, in the second vibration pattern, the control device causes the second vibration devices to vibrate in order from the upper second vibration devices to the lower second vibration devices, and then causes the first vibration devices to vibrate in order from the rear first vibration devices to the front first vibration devices.

3. The vehicle seat system of claim 2, wherein,
when determining, based on the external information, that an object is present frontward of the vehicle, the control device causes the first and second vibration devices to vibrate in the first vibration pattern, whereas, when determining that an object is present rearward of the vehicle, the control device causes the first and second vibration devices to vibrate in the second vibration pattern.

4. The vehicle seat system of claim 3, wherein the control device causes the first and second vibration devices to vibrate in order, at predetermined intervals, and is configured to change the intervals based on the external information.

5. The vehicle seat system of claim 4, wherein the control device changes the intervals based on the external information such that the closer the distance between the vehicle and the object is, the shorter the intervals.

6. The vehicle seat system of claim 1, further comprising an acceleration sensor for detecting an acceleration of the vehicle,
wherein the first vibration devices comprise a first set of vibration devices including a plurality of front first vibration devices located in a front part of the seat cushion and a second set of vibration devices including a plurality of rear first vibration devices located in a rear part of the seat cushion, and
the second vibration devices comprise a third set of vibration devices including a plurality of lower second vibration devices located in a lower part of the seatback and a fourth set of vibration devices including a plurality of upper second vibration devices located in an upper part of the seatback, and
wherein, when the acceleration of the vehicle is below a predetermined threshold value, the control device causes the first and second vibration devices to vibrate in order of the first, second, third, and fourth sets of vibration devices.

7. The vehicle seat system of claim 1, further comprising an occupant detection device for detecting that an occupant is seated in the seat body,
wherein when determining, based on a signal from the occupant detection device, that an occupant is not seated in the seat body, the control device prohibits the first and second vibration devices from vibrating.

8. The vehicle seat system of claim 1, further comprising a rotation angle sensor for detecting a rotation angle of the seat body,
wherein, when an object is present frontward of the vehicle and the rotation angle is less than a predetermined threshold value, the control device determines that the seat body is facing frontward and causes the first vibration devices to vibrate, followed by causing the second vibration devices to vibrate, whereas,
when an object is present frontward of the vehicle and the rotation angle is equal to and greater than the predetermined threshold value, the control device determines that the seat body is facing rearward and causes the second vibration devices to vibrate, followed by causing the first vibration devices to vibrate.

9. The vehicle seat system of claim 8, wherein, when the object is present frontward to a first side of the vehicle, the first side being one of the left and right side and a second side being the other, and the rotation angle is less than the predetermined threshold value, the control device determines that the seat body is facing frontward and causes the first and second vibration devices provided on the first side of the seat body to vibrate, followed by causing the first and second vibration devices provided on the second side of the seat body to vibrate, whereas,
when the object is present frontward to the first side of the vehicle and the rotation angle is equal to or greater than the predetermined threshold value, the control device determines that the seat body is facing rearward and causes the first and second vibration devices provided on the second side of the seat body to vibrate, followed by causing the first and second vibration devices on the first side of the seat body to vibrate.

10. The vehicle seat system of claim 1, wherein the seatback includes a pressure receiving member with main surfaces facing frontward and rearward of the seat body, the pressure receiving member being configured to receive a pressure applied from a body of an occupant seated in the seat body, and
wherein the second vibration devices are provided frontward of, and not overlapping with the pressure receiving member in a front-rear direction.
